(19) United States
(12) Patent Application Publication
(10) Pub. No.: US 2026/0071702 A1
(43) Pub. Date: Mar. 12, 2026

(54) SPOOLABLE PIPE FIELD END REINFORCEMENT

(71) Applicant: Fiber Glass Systems, L.P., Houston, TX (US)

(72) Inventors: James Pisarkiewicz, San Antonio, TX (US); David Wayne Granderson, San Antonio, TX (US)

(21) Appl. No.: 19/128,075

(22) PCT Filed: Aug. 9, 2023
(86) PCT No.: PCT/US2023/071933

§ 371 Date: May 7, 2025

Related U.S. Application Data
(63) Continuation of application No. PCT/US2022/079445, filed on Nov. 8, 2022.

(51) Int. Cl. F16L 33/22

(52) U.S. Cl. CPC F16L 33/224

(57) ABSTRACT

A pipe connection for connecting or terminating a composite pipe can include a housing, a slip including a first tapered surface, a sleeve including a first cam surface, the second coupling surface configured to engage the housing to secure the sleeve to the housing, and the first cam surface configured to engage the first tapered surface of the slip to compress the slip to into engagement with the composite pipe when the sleeve is secured to the housing. The pipe connection can further include a mandrel including a head portion configured to compress the slip to engage the composite pipe with a compression force proportional to a fluid pressure within the composite pipe.

### PRIORITY CLAIM

This application claims the benefit of priority to International Application No. PCT/US2022/079445, filed Nov. 8, 2022, which is incorporated herein by reference in its entirety.

### TECHNICAL FIELD

The present disclosure relates to systems and methods for connecting, terminating, or reinforcing various types of piping, tubing, or other elongated elements defining a longitudinal lumen. More particularly, but not by way of limitation, the present disclosure relates to a system and method for connecting, terminating, or axially reinforcing composite piping, or other types of non-metallic piping.

### BACKGROUND

The background description below is provided for the purpose of presenting the general context of the disclosure. Work of the presently named inventors, to the extent it is described in this background section, as well as aspects of the background description that may not otherwise qualify as prior art at the time of filing, are neither expressly nor impliedly admitted as prior art against the present disclosure.

Spoolable composite piping continues to be in widespread industrial use, such as in fossil fuel or chemical production and handling operations. During such operations, it is generally necessary to establish various pipe connections, such as to fluidly connect tools or various devices to a composite pipe, fluidly connect a composite pipe to a wellhead, fluidly connect two separate sections of composite pipe, or seal an open end of a composite pipe. However, for numerous reasons, establishing a strong and reliable high pressure composite pipe connection can be a difficult task. First, for example, composite piping is not well suited to many relatively high strength direct connection techniques, such as welding, often used to connect sections of piping made from steel or various metal alloys.

Second, composite piping can suffer from a variety of issues not associated with piping made from steel, various metal alloys, or many other materials. For example, composite piping can suffer from plastic deformation (e.g., plastic flow, plastic creep, or thermal ratcheting) or delamination, such as caused by environmental temperature, continuous internal or external pressure, or shear forces. These issues significantly reduce the amount of tensile load (e.g., force) that a composite pipe connection can withstand, and as such, often contribute to the failure of composite pipe connections. Third, while composite piping is commonly manufactured with one or more fiber-reinforced layers configured to help the composite piping resist swelling-type expansion and longitudinal extension, such fiber-reinforced layers are often ineffective once a rigid pipe connection is established. For example, spoolable composite piping is generally designed to resist a free-end loading (e.g., unconnected) condition, such as by aligning a wind angle of the one or more fiber-reinforced layers to the anticipated resultant of the hoop and axial forces experienced by a majority of the pipe length. In a free-end loading condition, the hoop load experienced by a composite pipe can be about twice the axial load experienced by the composite pipe. Accordingly, fiber-reinforced layers of composite piping are often oriented or aligned within a pipe wall to provide the highest strength and resilience when a hoop to axial load ratio is about two to one.

However, existing rigid end pipe connectors or terminations restrain an outer surface of a composite pipe from swelling in the radial direction, which can, in turn, create a loading condition that is substantially different from the loading condition experienced by the majority of the pipe length. For example, once an end of a composite pipe is compressed within a pipe connection, the end of the composite pipe engaged by the connector will be unable to circumferentially grow to thereby maintain the hoop to axial load ratio experienced by the rest of the composite pipe. This can cause the hoop to axial load ratio in the section of pipe engaged by the connector to be significantly lower than the majority of the pipe that is not engaged by, or is immediately adjacent to, the connector, and as such, the wind angle of any fiber-reinforced layers within the composite pipe may no longer be aligned to the resultant of the hoop and axial forces acting on the open end where the connector engages the pipe.

As such, in restrained end loading conditions, an unreinforced or less-resilient layer of the composite pipe, such as a thermoplastic inner liner, can experience an increased portion of a total axial load acting on the composite pipe. In response, the composite pipe can begin to neck down and plastically deform, flow out of, or otherwise creep or slip, relative to an end connector of a pipe connection, which can continue until an axial load limit (e.g., the maximum axial or tensile load that a pipe connection can withstand) of the pipe connection is exceeded. Moreover, composite pipe connections have, historically, included a rigid connector that is permanently affixed to, such as by crimping or swaging, an open end of a composite pipe. In such pipe connections, a fixed compression force is applied to an outer surface or diameter of the open end to establish a fluid tight seal between various components of the pipe connection and the composite pipe; and the open end is maintained in a fixed position within the pipe connection. However, such pipe connections cannot effectively respond to significant increases in axial load within the composite pipe, as the compression force applied to the open end of the composite pipe is directly proportional to the axial load limit of the pipe connection,

In view of the above, existing composite pipe connections are unable to prevent the effects of plastic deformation, such as caused by relatively high environmental temperatures, continuous internal or external pressure, or other factors, from reducing the tensile load limit of the pipe connection over time. Additionally, as the composite pipe is maintained in a fixed position within existing composite pipe connections, such connections cannot help to mitigate a shear force differential, such as between shear force acting on inner layer and shear force acting on an outer layer of a composite pipe, from contributing to or causing delamination of the composite pipe.

### SUMMARY

The following presents a simplified summary of one or more embodiments of the present disclosure in order to provide a basic understanding of such embodiments. This summary is not an extensive overview of all contemplated embodiments; and is intended to neither identify key or critical elements of all embodiments, nor delineate the scope of any or all embodiments.

In one or more embodiments, a pipe connection for connecting or terminating a composite pipe can include a housing including a first coupling surface, a slip including a first tapered surface, a sleeve including a second coupling surface and a first cam surface, and a mandrel including a head portion configured to engage the slip to compress the composite pipe with a compression force proportional to a fluid pressure within the composite pipe. The second coupling surface of the sleeve can be configured to engage the first coupling surface of the housing to secure the sleeve to the housing, and the first cam surface of the sleeve can be configured to engage the first tapered surface of the slip to compress the slip into engagement with the composite pipe when the sleeve is secured to the housing. The mandrel can also include an insertion portion configured to extend into an inner liner of the composite pipe to resist deformation of the composite pipe.

In one or more embodiments, a pipe connection for connecting or terminating a composite pipe can include a housing including a first coupling surface, a slip including a first tapered surface, a sleeve including a second coupling surface and a first cam surface, a mandrel, and a strain relief element configured to compress the composite pipe with a compression force proportional to a longitudinal distance between a first end and a second end of the strain relief element. The second coupling surface of the sleeve can be configured to engage the first coupling surface of the housing to secure the sleeve to the housing, and the first cam surface of the sleeve can be configured to engage the first tapered surface of the slip to compress the slip into the composite pipe when the sleeve is secured to the housing. The mandrel can also include a head portion configured to engage the slip to compress the composite pipe with a compression force proportional to a fluid pressure within the composite pipe.

In one or more embodiments, a pipe connection for connecting or terminating a composite pipe can include a housing including a first coupling surface, a slip including a first contacting surface, a sleeve including a second coupling surface and a second contacting surface, a mandrel, and a longitudinal spring adapted to be received about a head portion of the mandrel. The second coupling surface of the sleeve can be configured to engage the first coupling surface of the housing to secure the sleeve to the housing; and the first tapered surface of the sleeve can be configured to engage the first cam surface of the slip to compress the slip into the composite pipe when the sleeve is secured to the housing, and the longitudinal spring can be adapted to engage the slip to cause the slip to compress the composite pipe against the insertion portion. The mandrel can also include an insertion portion configured to extend into an inner liner of the composite pipe to resist deformation of the composite pipe.

In one or more embodiments, a pipe connection for connecting or terminating a composite pipe can include a housing including a first coupling surface, a slip including a first contacting surface, a sleeve including a second coupling surface and a second contacting surface, a mandrel, and one or more radial springs extending radially through the housing. The second coupling surface of the sleeve can be configured to engage the first coupling surface of the housing to secure the sleeve to the housing; and the first contacting surface of the sleeve can be configured to engage the second contacting surface of the slip to compress the slip to into engagement with the composite pipe when the sleeve is secured to the housing, and the one or more radial springs adapted to engage the first contacting surface of the slip to compress the composite pipe against the insertion portion. The mandrel can also include an insertion portion configured to extend into an inner liner of the composite pipe to resist deformation of the composite pipe.

While multiple embodiments are disclosed, still other examples of the present disclosure will become apparent to those skilled in the art from the following detailed description, which shows and describes illustrative embodiments of the invention. As will be realized, the various embodiments of the present disclosure are capable of modifications in various obvious aspects, all without departing from the spirit and scope of the present disclosure. Accordingly, the drawings and detailed description are to be regarded as illustrative in nature and not restrictive.

### BRIEF DESCRIPTION OF THE DRAWINGS

While the specification concludes with claims particularly pointing out and distinctly claiming the subject matter that is regarded as forming the various embodiments of the present disclosure, it is believed that the invention will be better understood from the following description taken in conjunction with the accompanying Figures, in which:

FIG. 1 illustrates a side view of a piping spool deploying a composite pipe including a pipe connection, according to one or more examples of the present disclosure.

FIG. 2 illustrates side view with a partial cutaway cross-section of a pipe connection, according to one or more examples of the present disclosure.

FIG. 3 illustrates a side view of a pipe connection including a strain relief element, according to one or more examples of the present disclosure.

FIGS. 4A-4B illustrate side views of a composite pipe including an axial reinforcement layer, according to one or more examples of the present disclosure.

FIG. 5 illustrates a method for connecting or terminating a composite pipe, according to one or more examples of the present disclosure.

FIGS. 6A-6B illustrate cutaway views of a pipe connection including a slip having a plurality of segments, according to one or more examples of the present disclosure.

FIG. 7 illustrates a cross-section of a pipe connection, according to one or more examples of the present disclosure.

FIG. 8 illustrates a partial cross-section of a slip including a plurality of distal slits, according to one or more examples of the present disclosure.

FIG. 9 illustrates a partial cross-section of a slip including an annular insert, according to one or more examples of the present disclosure.

FIG. 10 illustrates a cross-section of a pipe connection including a strain relief element and a locking system, according to one or more examples of the present disclosure.

FIGS. 11-12 illustrate cross-sections of a pipe connection including a locking system, according to one or more examples of the present disclosure.

FIG. 13A illustrates a side view of an example pipe connection including a strain relief element, according to one or more examples of the present disclosure.

FIG. 13B illustrates a side view of an example retaining ring and a strain relief element, according to one or more examples of the present disclosure.

FIG. 13C illustrates a front view of an example retaining ring, according to one or more examples of the present disclosure.

FIGS. 14A-14B illustrate cross-sections of an example pipe connection, according to one or more examples of the present disclosure.

FIG. 15 illustrates an example pipe connection including a strain relief element, according to one or more examples of the present disclosure.

FIG. 16 illustrates an example pipe connection including a strain relief element secured to a slip, according to one or more examples of the present disclosure.

FIG. 17 illustrates an example pipe connection including a longitudinal spring, according to one or more examples of the present disclosure.

FIGS. 18-19 illustrate examples of pipe connections including one or more radial springs, according to one or more example of the present disclosure.

FIGS. 20-21 illustrate examples of pipe connections including one or more radial springs, according to one or more example of the present disclosure.

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

### DETAILED DESCRIPTION

The present disclosure, in one or more examples, relates to a high-pressure pipe connection that provides for active engagement with a composite pipe to enable the pipe connection to adapt to a wide range of tensile loads and help the pipe connection resist the effects of plastic deformation. For example, the pipe connection can include a mandrel configured to translate longitudinally axially within the pipe connection to cause a slip to compress a composite pipe with a force proportional to fluid pressure within the composite pipe. By varying the hoop compression force on the composite pipe in proportion to axial tensile force or load acting on a pipe connection, the pipe connection of the present disclosure can help to improve the tensile load carrying capacity of composite pipe connections and help to prevent plastic deformation from reducing the axial tensile force limit of a composite pipe connection. Additionally, the pipe connection of the present disclosure can help composite pipe connections prevent delamination of composite piping. For example, the composite pipe connection can enable a composite pipe engaged by the mandrel and the slip to move longitudinally axially within the pipe connection, such as to prevent a force differential between a shear force on an inner layer and a shear force on an outer layer of a composite pipe from arising.

In a further example, the pipe connection of the present disclosure can include a strain relief element to help further increase the tensile load carrying capacity of the pipe connection over existing composite pipe connections that engage a pipe with or without a fixed compression force. For example, the strain relief element can enable the pipe connection to compress an increased length of the composite pipe to transfer axial force from the composite pipe to the pipe connection, such as to reduce the amount of axial load supported or otherwise carried by any individual point, area, or portion within the composite pipe.

In a still further example, the pipe connection of present disclosure can include a longitudinal spring, or one or more radial springs, to help increase the tensile load carrying capacity of the pipe connection over existing composite pipe connections that engage a pipe with a fixed compression force. For example, the longitudinal spring, or the one or more radial springs, can cause a slip to compress a composite pipe with a constant compression force that is proportional to a compressive force of the longitudinal spring, or the one or more radial springs, to thereby maintain a hoop compression force on the composite pipe irrespective of plastic deformation of the composite pipe. In an additional example, the pipe connection of the present disclosure can include an axial reinforcement layer that, in contrast to existing methods of axially strengthening composite piping, can be applied to a reduced length section of a composite pipe not having any manufacturing treatments or other modifications, and that is cut from a piping spool at an installation site without prior knowledge of a final cut location or final overall length, such as at a wellhead. For example, the axial reinforcement layer can be bonded to an outer pipe surface of the composite pipe, such as after the composite pipe is cut or severed at the connection location, to enable significant portion, or all, of the total axial load acting on the composite pipe to be supported or otherwise carried by the axial reinforcement layer.

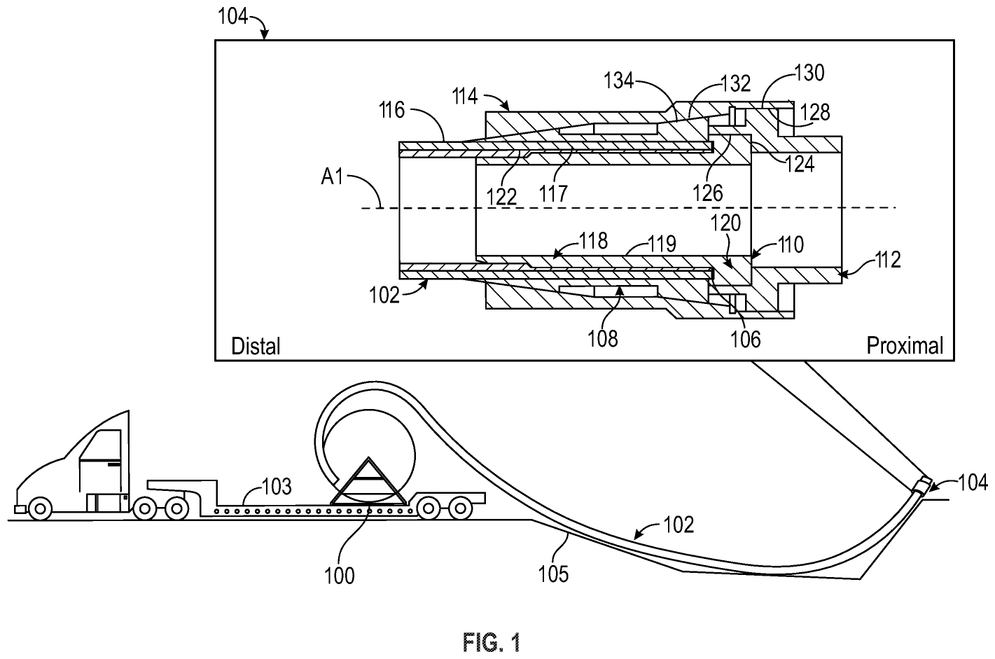

FIG. 1 illustrates a side view of a piping spool 100 deploying a composite pipe 102 including a pipe connection 104, according to one or more examples of the present disclosure. Also shown in FIG. 1 is a longitudinal axis A1, and orientation indicators Proximal and Distal. The piping spool 100 can be located on a trailer 103, such as to enable the piping spool 100 to be transported to various locations. The piping spool 100 can facilitate rapid deployment of the composite pipe 102, such as along an above-grade, or a below-grade, ground surface 105. After deployment of the composite pipe 102, such as after spooling out hundreds or thousands of feet of the composite pipe 102, the pipe connection 104 can be established. For example, the pipe connection 104 may be used to fluidly connect an open end 106 of the composite pipe 102 to another composite pipe, fluidly connect the open end 106 of the composite pipe 102 to a wellhead or various tools, or seal the open end 106 of the composite pipe 102.

The pipe connection 104 can include a slip 108, a mandrel 110, a housing 112, and a sleeve 114. The slip 108 can be sized and shaped to slide over the open end 106 of the composite pipe 102, such as to contact and engage an outer pipe surface 116 of the composite pipe 102. In one example, such as shown in FIG. 1, the outer pipe surface 116 can be defined by a reinforcement layer 117 of the composite pipe 102. In some examples, the reinforcement layer 117 can include a fiber-reinforced, or high relative tensile modulus reinforcement material (HRTMRM).

The reinforcement layer 117 can generally represent the reinforcement layers common in many composite pipes. For example, the reinforcement layer 117 can include resilient fibers aligned, oriented, or otherwise adapted to resist the resultant force of anticipated hoop and axial forces the composite pipe 102 is configured to carry in a free end or otherwise unconnected state. The mandrel 110 can include an insertion portion 118 and a head portion 120. The insertion portion 118 can be configured to extend into an inner liner 122 of the composite pipe 102. In one example, such as shown in FIG. 1, the inner liner 122 can be made from a non-fiber reinforced material, such as, but not limited to, high density polyethylene (HDPE) or other thermoplastic polymers.

The insertion portion 118 can be configured to help the composite pipe 102 resist elastic and plastic deformation when under a compression force provided by the slip 108. For example, the insertion portion 118 can define a relatively large wall thickness adapted to resist compressive forces, while being thin enough to define a mandrel bore 119 having a diameter small enough to avoid inhibiting fluid flow there through. The head portion 120 can extend longitudinally between the slip 108 and an end surface 124 of the housing 112. The housing 112 can include a housing bore 126. The housing bore 126 can be sized and shaped to translatably or slidably receive the head portion 120 of the mandrel 110. The sleeve 114 can be adapted for sleeving over the slip 108 and at least a portion of the housing 112. The housing 112 can include a first coupling surface 128, the sleeve 114 can include a second coupling surface 130 and a first cam surface 132, and the slip 108 can include a first tapered surface 134.

The second coupling surface 130 can be configured to engage the first coupling surface 128 of the housing 112 to secure the sleeve 114 to the housing 112. The first cam surface 132 can be configured to contact and engage the first tapered surface 134. The sleeve 114 can cause the slip 108 to apply a fixed compression force to the open end 106 of the composite pipe 102. For example, as the sleeve 114 is secured to the housing 112, the first cam surface 132 can slide along the first tapered surface 134 to compress the slip 108 into engagement with the outer pipe surface 116. The mandrel 110 can cause the slip 108 to apply an additional, and variable, compression force to the open end 106 of the composite pipe 102, such as beyond the fixed compression force, or initial preload, provided by the sleeve 114. For example, once fluid enters the pipe connection 104, hydraulic pressure can build between the head portion 120 and the end surface 124 of the housing 112; and cause the first cam surface 132 to slide further distally along the first tapered surface 134 to thereby compress the slip 108 and the composite pipe 102.

Additionally, longitudinal shrinkage of the composite pipe 102, such as caused by relatively high pressures within the inner liner 122 when both open ends, such as the open end 106, and an opposite open end, are restrained, can help to improve the ability of the slip 108 and the mandrel 110 to apply an additional, and variable, compression force to the open end 106 of the composite pipe 102. For example, distal movement of the composite pipe 102, such as due to longitudinal shrinkage, plastic flow or extrusion, or other factors, can cause the open end 106 of the composite pipe 102 to move in a distal direction relative to the sleeve 114; and cause the first cam surface 132 to slide further distally along the first tapered surface 134 to thereby compress the slip 108 and the composite pipe 102.

In the operation of some examples, the composite pipe 102 can be deployed from the piping spool 100 to a connection location, such as to a wellhead. The composite pipe 102 can be cut, or otherwise severed, to expose the open end 106 of the composite pipe 102. The sleeve 114 can be positioned over the open end 106 of the composite pipe 102 and then moved in a distal direction along the composite pipe 102. The slip 108 can be slipped over the open end 106, such as into a longitudinal position located approximately flush with the open end 106, and the mandrel 110 can be inserted into the inner liner 122, such as until the head portion 120 contacts the outer pipe surface 116. The sleeve 114 can then be moved proximally back along the composite pipe 102, such as until the sleeve 114 is positioned longitudinally over the slip 108 and the head portion 120 of the mandrel 110 and the first coupling surface 128 is engaged with the second coupling surface 130 of the housing 112.

As the sleeve 114 moves toward the head portion 120 of the mandrel 110, the first tapered surface 134 of the slip 108 can slide along the first cam surface 132 of the slip 108 to compressively clamp the composite pipe 102 against the insertion portion 118 of the mandrel 110 with a compression force provided by the inward pressure exerted by the sleeve 114. Once the pipe connection 104 is established, fluid can begin flowing through the composite pipe 102, such as from a fluid source, and into the pipe connection 104. In turn, an amount of fluid can flow between the head portion 120 and the end surface 124 of the housing 112 to cause the first cam surface 132 to move further distally along the first tapered surface 134 and force the slip 108 to compressively clamp the open end 106 against the insertion portion 118 of the mandrel 110. The pipe connection 104 can thereby engage the composite pipe 102 with a compression force proportional to the fluid pressure within the composite pipe 102.

In view of the above, the pipe connection 104 of the present disclosure can provide several benefits over existing composite pipe connections. First, by increasing compression on the outer pipe surface 116 proportionally to fluid pressure within the composite pipe 102, the tensile load carrying capacity of pipe connection 104 is not degraded or reduced due to plastic creep, extrusion, or thermal ratcheting observed at common operating pressures and temperatures, such as relative to existing composite pipe connections that engage a pipe with a fixed compression force.

Second, by compressively clamping the open end 106 between movable components (e.g., the mandrel 110 and the slip 108), the pipe connection 104 can withstand a significantly greater amount of plastic deformation of the composite pipe 102 before failure, such as relative to existing composite pipe connections that engage a pipe with a fixed compression force. For example, if the open end 106 begins to creep, flow, or slip, or otherwise move or deform within the pipe connection 104, the mandrel 110 and the slip 108 can move longitudinally along with the open end 106 to maintain a consistent compression force thereon. This can additionally help to improve the heat resistance and longevity of composite pipe connections, as both relatively high ambient temperatures, and relatively long periods of time, can significantly intensify the detrimental effects of plastic deformation.

Third, by allowing the composite pipe 102 to move longitudinally within the pipe connection 104, the pipe connection 104 can significantly reduce the likelihood of delamination of the composite pipe 102, such as relative to existing composite pipe connections that maintain a pipe in a fixed longitudinal position. For example, as both the outer pipe surface 116 and the inner liner 122 of the composite pipe 102 are engaged by components that move concurrently with one another (e.g., the mandrel 110 and the slip 108), the pipe connection 104 can prevent a force differential, such as between a shear force acting on the outer pipe surface 116 and a shear force acting on the inner liner 122, from arising and causing the outer pipe surface 116 to separate from the inner liner 122.

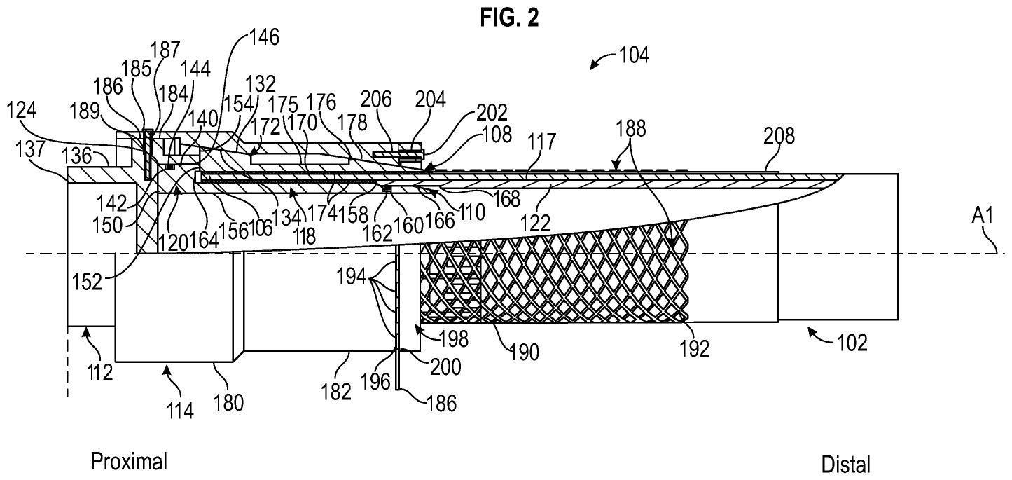

FIG. 2 illustrates side view with a partial cutaway cross-section of a pipe connection 104, according to one or more examples of the present disclosure. Also shown in FIG. 2 is a longitudinal axis A1, and orientation indicators Proximal and Distal. FIG. 2 is discussed with reference to the pipe connection 104 shown in, and described with regard to, FIG. 1 above. The housing 112 can include an extension portion 136 extending proximally beyond the sleeve 114. The extension portion 136 can define an inner bore 137. The inner bore 137 can be adapted to reduce the weight of the pipe connection 104 and/or allow for fluid flow there through. In some examples, the pipe connection 104 can be configured as a termination. In such examples, the mandrel 110 can be adapted to seal the open end 106 (FIG. 1) of the composite pipe 102, such as shown in FIG. 2, such as by preventing fluid flow through the inner bore 137.

In other examples, the pipe connection 104 can be configured to function as a fluid connection, such as to fluidly couple the composite pipe 102 to a wellhead, another composite pipe, tools, or various other systems or devices. In such examples, the housing 112 can be a double-ended housing, such as opposed to a single-ended housing as illustrated in FIGS. 1-2; and the pipe connection can include two of the slips 108, two of the mandrels 110, and two of the sleeves 114. Further, in such examples, the mandrel 110 can be adapted to enable fluid flow through the inner bore 137, such as illustrated in FIG. 1. As such, while the discussion of the pipe connection 104 herein relates to a single-sided pipe connection, it is also applicable to a double sided-pipe connection.

The head portion 120 of the mandrel 110 can include an outer head surface 140. The outer head surface 140 can define an outer diameter adapted for relatively snug engagement with the housing bore 126 of the housing 112. The outer head surface 140 can define one or more first sealing slots 142. In various examples, the one or more first sealing slots 142 can include one, two, three, four, or other numbers of sealing slots, such as spaced longitudinally apart relative to the longitudinal axis A1. Each of the one or more first sealing slots 142 can be sized and shaped to receive a first sealing element 144. The first sealing element 144 can be an O-ring, such as made from, but not limited to, polyurethane, various elastomeric or polymeric materials, or other relatively resilient sealing materials. When received within one of the one or more first sealing slots 142, the first sealing element 144 can be configured to establish a fluid tight seal between the outer head surface 140 and an inner surface 146 of the housing 112 defining the housing bore 126. For example, the first sealing element 144 can be sized and shaped such that when the head portion 120 is inserted into the housing bore 126, the first sealing element 144 can be compressed by the inner surface 146 of the housing 112 into a sealing slot of the one or more first sealing slots 142.

The head portion 120 can include a first surface 150 and a second surface 152. The first surface 150 can be a proximal-most surface of the head portion 120 and the second surface 152 can be a distal-most surface of the head portion 120. The first surface 150 and the second surface 152 can extend parallel to each other, to the end surface 124, and to an abutment surface 154 of the slip 108, which can be a proximal-most surface of the slip 108. The longitudinal length of the head portion 120, such as defined by the longitudinal distance between the first surface 150 and the second surface 152, and the number of sealing slots that the one or more first sealing slots 142 includes, can be selected based on the anticipated fluid pressure range within the composite pipe 102, the diameter of the inner liner 122, or other factors.

When the head portion 120 is located within the housing bore 126, the first surface 150 can oppose the end surface 124 of the housing 112; and the second surface 152 can oppose the abutment surface 154 of the slip 108. Once the sleeve 114 is secured to the housing 112, the first surface 150 can contact and engage the end surface 124 of the housing 112; and the second surface 152 can contact and engage the abutment surface 154. When pressurized fluid enters the pipe connection 104 through the inner liner 122 of the composite pipe 102, hydraulic pressure can build between the first surface 150 of the head portion 120 and the end surface 124 of the housing 112. This can cause the outer head surface 140 to slide longitudinally axially along the inner surface 146 of the housing 112 and toward the abutment surface 154 of the slip 108, and concurrently prevent the insertion portion 118 of the mandrel 110 from moving proximally relative to the inner liner 122, such as to maintain the mandrel 110 in the composite pipe 102.

The mandrel 110 can include an inner insertion surface 156. The inner insertion surface 156 can define the mandrel bore 119 (FIG. 1), which can be adapted to enable fluid to flow through the mandrel 110 and into the inner bore 137 of the housing 112, such as when the mandrel 110 and the pipe connection 104 are configured for fluid connection and not pipe termination. The first surface 150 can be sized and shaped to apply different amounts of compressive force to the slip 108. For example, a vertical distance between the inner insertion surface 156 and the outer head surface 140 of the mandrel 110 can be increased to cause the head portion 120 to apply more compressive force to the abutment surface 154 of the slip by increasing a surface area of the first surface 150. Alternatively, the vertical distance between the inner insertion surface 156 and the outer head surface 140 of the mandrel 110 can be decreased to cause the head portion 120 to apply less compressive force to the abutment surface 154 of the slip by decreasing the surface area of the first surface 150.

The mandrel 110 can include an outer insertion surface 158. The outer insertion surface 158 can be adapted for insertion into the composite pipe 102. For example, when the insertion portion 118 is inserted into the open end 106, the outer insertion surface 158 can be sized and shaped to contact and engage the inner liner 122. The outer insertion surface 158 can define one or more second sealing slots 160. In various examples, the one or more second sealing slots 160 can include one, two, three, four, or other numbers of sealing slots, such as spaced longitudinally apart relative to the longitudinal axis A1. Each of the one or more second sealing slots 160 can be sized and shaped to receive a second sealing element 162. The second sealing element 162 can made from polyurethane, various elastomeric or polymeric materials, or other relatively resilient sealing materials. The second sealing element 162 can be an O-ring, such as made from, but not limited to, polyurethane, various elastomeric or polymeric materials, or other relatively resilient sealing materials.

The second sealing element 162 can be configured to establish a fluid tight seal between the outer insertion surface 158 and the inner liner 122 of the composite pipe 102. For example, the second sealing element 162 can be sized and shaped such that when the insertion portion 118 is inserted into the composite pipe 102, the second sealing element 162 can be compressed by the inner liner 122 into a sealing slot of the one or more second sealing slots 160. By preventing pressurized fluid within the pipe connection 104 from escaping between the mandrel 110 and the housing 112 or the inner liner 122, the first sealing element 144 and the second sealing element 162 can collectively enable hydraulic pressure to build between the head portion 120 of the mandrel 110 and the end surface 124 of the housing 112, such as to drive the mandrel 110 distally along the longitudinal axis A1.

The insertion portion 118 can be configured to extend into the open end 106 of the composite pipe 102 by various longitudinal distances. For example, the insertion portion 118 can be configured to extend into the open end 106 by a longitudinal distance about equal to a diameter of the inner liner 122. In other examples, the insertion portion 118 can be configured to extend into the open end 106 by increased or decreased longitudinal distances. The longitudinal length of the insertion portion 118, and the number of second sealing slots the one or more second sealing slots 160 includes, can be selected based on the anticipated fluid pressure range within the composite pipe 102, the diameter of the inner liner 122, or other factors.

The mandrel 110 can also include a face 164. The face 164 can be an annular surface of the head portion 120 arranged longitudinally adjacently to the insertion portion 118. The face 164 can extend vertically, such as orthogonally to the longitudinal axis A1, between the inner insertion surface 156 and the outer head surface 140. The face 164 can be configured to limit the longitudinal distance the insertion portion 118 can be inserted into the inner liner 122. For example, the face 164 can define a diameter greater than a diameter defined by the outer insertion surface 158 to prevent further distal translation once the face 164 contacts the open end 106. The face 164 can be proximally and longitudinally offset, relative to the second surface 152 of the head portion 120, such as to allow the open end 106 to extend a longitudinal distance into the head portion 120. This can help to prevent slipping of the composite pipe 102 relative to the slip 108. For example, in operation, a portion of the open end 106 extending proximally into the head portion 120 can remain uncompressed by the slip 108; and can thus extend radially outwardly beyond the abutment surface 154 of the slip 108.

In some examples, the outer insertion surface 158 can include a tapered or stepped bore type distal surface 166. The tapered distal surface 166 can be distal portion or segment of the outer insertion surface 158. The tapered distal surface 166 can be adapted to engage a recessed portion 168 of the inner liner 122. For example, prior to insertion into the open end 106, the inner liner 122 can optionally be reamed by a user to define or otherwise shape the recessed portion 168. The recessed portion 168 can help to reduce the volume of relatively flowable or compressible material, such as of the inner liner 122 that can flow, or can otherwise be displaced, before the mandrel 110 begins to engage less flowable or compressible layers of the composite pipe 102, such as the reinforcement layer 117. For example, the recessed portion 168 can be sized and shaped to reduce the thickness of the inner liner 122 in engagement with the mandrel 110, such as to allow to allow for the inner liner 122 to be a dual-layer, or multi-polymer, inner liner. In such an example, an innermost portion of the inner liner can be made from a relatively high performance and higher cost material, such as adapted to resist deterioration due to fluid exposure, and an outermost portion, such as in contact with the reinforcement layer 117, can be made from a more production compatible or lower cost material.

In such examples, such as shown in FIG. 2, at least one of the one or more second sealing slots 160 can be defined in the tapered or stepped distal surface 166 to prevent fluid leak between the recessed portion 168 and the tapered distal surface 166. The slip 108 can include an inner slip surface 170 and an outer slip surface 172. The outer slip surface 172 can include the first tapered surface 134. The inner slip surface 170 and the outer insertion surface 158 can be adapted for resisting motion of the composite pipe 102 relative to the slip 108 and the mandrel 110, respectively. For example, the inner slip surface 170 and the outer insertion surface 158 can each include one or more pipe-engaging features 174. The one or more pipe-engaging features 174 can be configured to bitingly engage the outer pipe surface 116 and the inner liner 122 of the composite pipe 102, respectively.

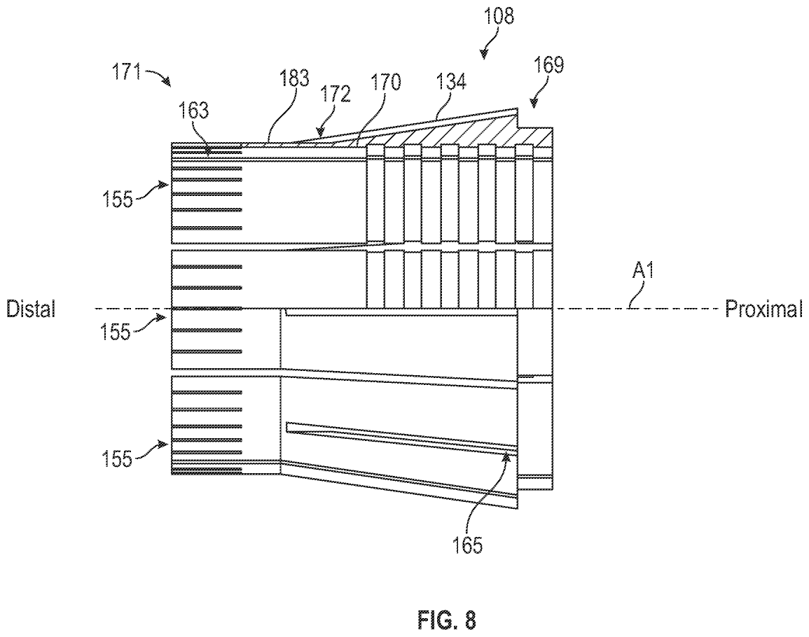

In some examples, the one or more pipe-engaging features 174 can be a plurality of teeth. In other examples, the one or more pipe-engaging features 174 can be one or more ribs, protrusions, or projections defining various three-dimensional shapes and extending radially inward from the inner slip surface 170 and radially outward from the outer insertion surface 158. In still further examples, the inner slip surface 170 and the outer insertion surface 158 may not include the one or more pipe-engaging features 174, such as shown in FIG. 1. In such examples, the inner slip surface 170 and the outer insertion surface 158 can be substantially smooth or featureless annular surfaces. In such examples, a compression force provided to composite pipe 102 by slip 108, the mandrel 110, and the sleeve 114 can be sufficient, or otherwise adequate, to prevent or resist distal motion of the composite pipe 102 relative to the slip 108, the mandrel 110, and sleeve 114. In some examples, such as shown in FIGS. 8-19, the slip 108 can be a single taper slip and the sleeve 114 can be a single taper sleeve.

In other examples, such as shown in FIGS. 1-2, the slip 108 can be double taper slip and the sleeve 114 can be a double taper sleeve. In such examples, the outer slip surface 172 can include the first tapered surface 134, a cylindrical surface 175, and a second tapered surface 176; and the sleeve 114 can include a second cam surface 178. The second cam surface 178 can be longitudinally distally offset from the first cam surface 132 along the sleeve 114; and the second tapered surface 176 can be longitudinally distally offset from the first tapered surface 134 along the slip 108 by the cylindrical surface 175. The first cam surface 132, the first tapered surface 134, the second cam surface 178, and the second tapered surface 176 can each define a substantially constant slope.

In some examples, the slope of the first cam surface 132 and the second cam surface 178, and the slope of the first tapered surface 134 and the second tapered surface 176, can be substantially similar, and such as, the first cam surface 132 and the second cam surface 178, and the first tapered surface 134 and the second tapered surface 176, can extend parallel to one another. Such a parallel and offset arrangement can help to the slip 108 and the sleeve 114 provide a substantially constant compression force along the entire longitudinal length of the slip 108, as well as help to maintain the slip 108 in a parallel alignment with the outer pipe surface 116 when the composite pipe 102. While not shown in FIG. 1-2, it can be appreciated that the slip 108 can be a single taper slip and the sleeve 114 can be a single tapered sleeve. For example, the first tapered surface 134 can extend a longitudinal length of the slip 108 and the first cam surface 132 can extend a longitudinal length of the sleeve 114.

The sleeve 114 can include a proximal portion 180 and a distal portion 182. In some examples, the proximal portion 180 can define a diameter that is greater than a diameter defined by the distal portion 182. The proximal portion 180 of the sleeve 114 can include the second coupling surface 130 (FIG. 1). In one example, the first coupling surface 128 (FIG. 1) of the housing 112 can define a first plurality of threads 184 and the second coupling surface 130 (FIG. 1) can define a second plurality of threads 186. The first plurality of threads 184 can be configured to threadedly engage the second plurality of threads 186, such as to secure the sleeve 114 to the housing 112.

In other examples, the first coupling surface 128 of the housing 112 can be a toothed surface and the second coupling surface 130 of the sleeve 114 can be a toothed surface. In such examples, the sleeve 114 can be a ratcheting device that slides over the first coupling surface 128 and is adapted to allow the sleeve 114 to move proximally across the first coupling surface 128 but prevent distal longitudinal motion of the sleeve 114 relative to the housing 112. In an additional example, such as shown in FIG. 2, the sleeve 114 can be secured to the housing 112 using one or more fasteners 185. In such an example, the proximal portion 180 of the sleeve 114 can define one or more first bores 187 and the housing 112 can define one or more second bores 189. Each bore of the one or more first bores 187 and each bore of the one or more second bores 189 can be configured to receive at least a portion of a fastener of the one or more fasteners 185.

The one or more first bores 187 can extend through the first coupling surface 128 of the housing 112, such as orthogonally to the longitudinal axis A1. The one or more second bores 189 can extend through the second coupling surface 130 of the sleeve 114, such as orthogonally to the longitudinal axis A1. The one or more first bores 187 and the one or more second bores 189 can be located about the housing 112 and the sleeve 114, respectively, in a radial or an annular arrangement. The one or more second bores 189 can be formed in corresponding radial positions relative to one or more first bores 187, such as to enable each bore of the one or more first bores 187 and each bore of the one or more second bores 189 to be aligned when the first coupling surface 128 positioned on the second coupling surface 130. One fastener of the one or more fasteners 185 can thereby be inserted through one bore one or more first bores 187 to engage one bore of the one or more second bores 189 to secure the sleeve 114 to the housing 112.

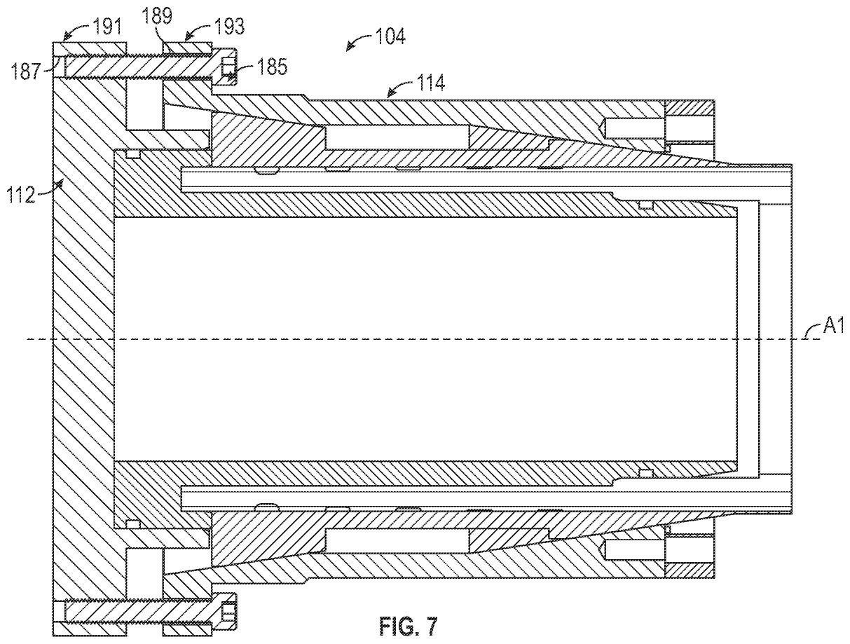

In an alternative example, as shown in FIG. 7, which illustrates a cross-section of a pipe connection 104, the one or more first bores 187 can extend through a first flanged portion 191 of the housing 112 parallel to, and laterally offset from, the longitudinal axis A1; and the one or more second bores 189 can extend through a second flanged portion 193 of the sleeve 114 parallel to, and laterally offset, from, the longitudinal axis A1. The first flanged portion 191 and the second flanged portion 193 can each be an annular protrusion or projection extending radially outward from the housing 112 and the sleeve 114, respectively. The one or more second bores 189 can be formed in corresponding radial positions relative to one or more first bores 187, such as to enable each bore of the one or more first bores 187 and each bore of the one or more second bores 189 to be aligned when the first flanged portion 191 of the housing 112 is positioned adjacently, or otherwise opposite to, the second flanged portion 193 of the sleeve 114. One fastener of the one or more fasteners 185 can thereby be inserted through one bore one or more first bores 187 to engage one bore of the one or more second bores 189 to secure the sleeve 114 to the housing 112.

The one or more first bores 187 and the one or more second bores 189 can include various numbers of individual bores, such as based on the number of individual fasteners the one or more fasteners 185 includes. The one or more first bores 187 and the one or more second bores 189 can each include two, three, five, or six, seven, nine, ten, or other numbers of bores, and the one or more fasteners 185 can include two, three, five, or six, seven, nine, ten, or other numbers of fasteners. In some examples, each bore of the one or more first bores 187 and each fastener of the one or more fasteners 185 can define corresponding threads, such as to allow each fastener of the one or more fasteners 185 to threadably engage each bore of the one or more first bores 187 to secure sleeve 114 to the housing 112. In other examples, each bore of the one or more second bores 189 can also be threaded, such as depending on the longitudinal length of threads defined by each fastener of the one or more fasteners 185. In still further examples, other coupling surfaces or features can be provided.

The slip 108, the mandrel 110, the housing 112, the sleeve 114, or other components of the pipe connection 104 can be made from one or a combination of several materials. In some examples, the slip 108, the mandrel 110, the housing 112, the sleeve 114, or other components of the pipe connection 104, can be made from hardened steel, metal alloys adapted for strength and/or corrosion resistance, coated metals (e.g., nickel, epoxy, etc.), stainless steel, corrosion resistant and/or sour resistant alloys, austenitic nickel-chromium-based superalloys such as Inconel®, and/or high chrome. In other examples, the slip 108, the mandrel 110, the housing 112, the sleeve 114, or other components of the pipe connection 104, can be made from one or more non-metallic materials, such as, but not limited to, a material including carbon fibers, glass fibers, or plastic fibers, Kevlar®, or various composite materials.

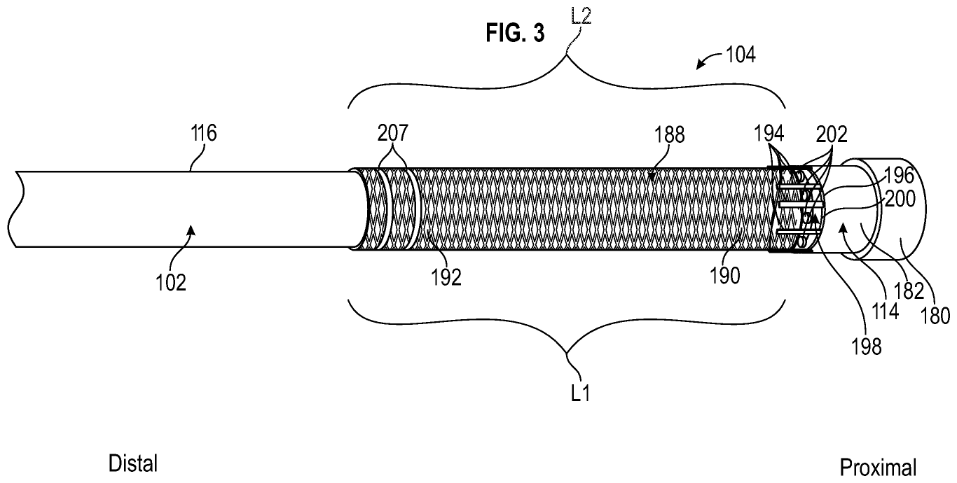

FIG. 3 illustrates a side view of a pipe connection 104 including a strain relief element 188, according to one or more examples of the present disclosure. Also shown in FIG. 3 are orientation indicators Proximal and Distal. In some examples, the pipe connection 104 can include the strain relief element 188. The strain relief element 188 is discussed with reference to FIGS. 2 and 3 concurrently. The strain relief element 188 can, in some examples, be a commercially available pipe-pulling cable grip, such as, but not limited to, a metallic wire-mesh or woven cable pulling grip. In other examples, the strain relief element 188 can be made from one or more non-metallic materials, such as, but not limited to, a material including carbon fibers, glass fibers, or plastic fibers, Kevlar®, or various composite materials.

The strain relief element 188 can be adapted to encompass a length L1 (FIG. 3) of the outer pipe surface 116 of the composite pipe 102. The length L1 can be a greater longitudinal distance, such as measured relative to the longitudinal axis A1 (FIG. 2) from the distal portion 182 of the sleeve 114, than a longitudinal length of the slip 108 (FIG. 2), the mandrel 110 (FIG. 2), the sleeve 114, or any other component of the pipe connection 104. In various examples, the length L1 can be, but is not limited to, between about two feet and about four feet, between about four feet and about six feet, or between about six feet and about eight feet.

In some examples, the strain relief element 188 can be sized and shaped to be slipped over, such as before or after the strain relief element 188, or a different cable pulling grip, is used to pull the composite pipe 102 to a connection location, and moved distally along, the composite pipe 102 when the strain relief element 188 is not under tensile load or otherwise subject to a longitudinal force or load. In other examples, the strain relief element 188 can be bonded to, or woven over, the length L1 of the composite pipe 102, such as after a different, or metallic, cable pulling grip is used to pull the composite pipe 102 to a connection location. For example, the strain relief element 188 can first be slipped over the length L1 of the composite pipe 102, and then one or more layers of thermally or chemically fusible material, such as, but not limited to, a thermoplastic or a composite material, can be slipped, wrapped, or woven around the length L1 to partially or completely encompass the strain relief element 188. Subsequently, the one or more layers of thermally or chemically fusible material can be thermally or chemically bonded, respectively, to the strain relief element 188 to thereby help prevent or limit movement of the strain relief element 188 along the outer pipe surface 116.

The strain relief element 188 can include a first end 190 and a second end 192. The first end 190 can be a proximal-most portion or segment of the strain relief element 188 and the second end 192 can be a distal-most portion or segment of the strain relief element 188. In some examples, the first end 190 can include a plurality of tabs 194. The plurality of tabs 194 can be distributed in a radial or annular arrangement about the first end 190; and can be fixedly coupled thereto. The plurality of tabs 194 can include various numbers of individual tabs, such as, but not limited to, two, three, four, five, six, seven, eight, or other numbers of tabs. The plurality of tabs 194 can be configured to enable the first end 190 of the strain relief element 188 to be secured to the sleeve 114. For example, each of the plurality of tabs 194 can define a planar shape, such as adapted to be clamped or otherwise retained between two opposing surfaces of the sleeve 114. In some examples, the plurality of tabs 194 can be made from various relatively ductile or flexible materials. In further examples, the plurality of tabs 194 can define, or otherwise represent, other shapes, or various styles of connectors, such as, but not limited to, hooks or eyelets.

The distal portion 182 of the sleeve 114 can define a distal end surface 196; and the pipe connection 104 can a include flange 198 defining a proximal end surface 200. In some examples, the distal end surface 196 and the proximal end surface 200 can extend orthogonally to the longitudinal axis A1. In other examples, the distal end surface 196 and the proximal end surface 200 can extend at various angles relative to the longitudinal axis A1. In still further examples, the distal end surface 196 and the proximal end surface 200 can include various materials or features adapted to help retain the plurality of tabs 194 between the distal end surface 196 and the proximal end surface 200.

The flange 198 can be removably coupled to the distal end surface 196 of the sleeve 114. For example, the pipe connection 104 can include a plurality of fasteners 202 for removably securing the flange 198 to the distal portion 182 of the sleeve 114. In such an example, the distal portion 182 of the sleeve 114 can include a first plurality of bores 204 (FIG. 2) and the flange 198 can define a second plurality of bores 206 (FIG. 2). Each bore of the first plurality of bores 204 and each bore of the second plurality of bores 206 can be configured to receive at least a portion of one of the plurality of fasteners 202.

The first plurality of bores 204 can extend through the distal end surface 196 and proximally into the sleeve 114, such as parallel to and laterally offset from the longitudinal axis A1. The second plurality of bores 206 can extend through the proximal end surface 200 and distally through the flange 198. The first plurality of bores 204 and the second plurality of bores 206 can be located about the distal portion 182 of the sleeve 114 and the flange 198, respectively, in a radial or an annular arrangement. The second plurality of bores 206 can be formed in corresponding radial positions relative to the first plurality of bores 204, such as to enable each bore of the first plurality of bores 204 and each bore of the second plurality of bores 206 to be axially aligned when the proximal end surface 200 is positioned on the distal end surface 196 of the sleeve 114. One fastener of the plurality of fasteners 202 can thereby be inserted through one bore of the second plurality of bores 206 to engage one bore of the first plurality of bores 204, such as to secure the flange 198 to the distal portion 182 of the sleeve 114.

The first plurality of bores 204 and the second plurality of bores 206 can include various numbers of individual bores, such as based on the number of individual fasteners the plurality of fasteners 202 includes. In one example, the first plurality of bores 204 and the second plurality of bores 206 can include eight bores, and the plurality of fasteners 202 can include eight fasteners. In other examples, the first plurality of bores 204 and the second plurality of bores 206 can include two, three, five, or six, seven, nine, ten, or other numbers of bores, and the plurality of fasteners 202 can include two, three, five, or six, seven, nine, ten, or other numbers of fasteners.

In some examples, each bore of the first plurality of bores 204 and each fastener of the plurality of fasteners 202 can define corresponding threads, such as to allow each fastener of the plurality of fasteners 202 to threadably engage each bore of the first plurality of bores 204 to secure the flange 198 to the sleeve 114. In other examples, each bore of the second plurality of bores 206 can also be threaded, such as depending on the longitudinal length of threads defined by each fastener of the plurality of fasteners 202. In still further examples, the flange 198 can be secured to the distal end surface 196 of the sleeve 114 with other types of fasteners.

In additional examples, the sleeve 114 may not include the flange 198. In some such examples, the first end 190 of the strain relief element 188 can be secured to the distal end surface 196 of the sleeve 114. For example, each fastener of the plurality of fasteners 202 can be directly inserted through the first end 190 of the strain relief element 188 to engage one bore of the first plurality of bores 204 to secure the flange 198 to the distal portion 182 of the sleeve 114. Alternatively, each tab of the plurality of tabs 194 can be configured to receive a portion of a fastener of the plurality of fasteners 202. For example, each tab of the plurality of tabs 194 can define an aperture, bore, or other opening sized and shaped to enable a fastener of the plurality of fasteners 202 to pass there through. In further examples, the first end 190 of the strain relief element 188 can be secured to other surfaces of the sleeve 114, such as to an outer diameter of the sleeve 114.

The second end 192 of the strain relief element 188 can be secured to the composite pipe 102, such as on an opposite side or longitudinal end of the length L1 relative to the first end 190. For example, the strain relief element 188 can be secured to the outer pipe surface 116 with one or more clamps 207 (FIG. 3). The one or more clamps 207, can be, for example, but not limited to, screw clamps, pinch clamps or various other styles of clamps adapted to compressively clamp the strain relief element 188 against the outer pipe surface 116. By securing the first end 190 to the sleeve 114 and the second end 192 to the outer pipe surface 116, the strain relief element 188 can frictionally or otherwise compressively engage the outer pipe surface 116 with a compression force proportional to, or otherwise based on, distal translation of the composite pipe 102 relative to the sleeve 114. For example, when the mandrel 110 the slip 108, and the composite pipe 102 move distally along the longitudinal axis A1 relative to the housing 112 and the sleeve 114, such as in response to hydraulic pressure between the mandrel 110 and the housing 112, the strain relief element 188 can be placed under tensile stress as a longitudinal distance L2 (FIG. 3) between the second end 192 or the one or more clamps 207, and the first end 190, increases. In response, the strain relief element 188 can shrink in diameter and compress a length of the composite pipe 102 encompassed by the strain relief element 188.

In view of the above, the strain relief element 188 can help the pipe connection 104 handle a greater tensile load over existing composite pipe connections that engage a pipe with a fixed compression force. For example, by compressing an increased length of the composite pipe 102 to transfer the tensile load on the composite pipe 102 to the pipe connection 104, the pipe connection 104 can reduce the amount of axial load experienced or otherwise supported by any individual portion of the composite pipe 102. As such, it can be appreciated that the strain relief element 188 may significantly increase the tensile load or force limit of the pipe connection 104 by reducing stresses that may be concentrated near, or at, each of the one or more pipe-engaging features 174. The strain relief element 188 can further help to support the composite pipe 102. For example, the strain relief element 188 may be less flexible or ductile relative to the composite pipe 102, such as to enable the strain relief element 188 help prevent or otherwise restrict pipe bending.

Additionally, while the strain relief element 188 is discussed above with regard to the pipe connection 104, it is to be appreciated that the strain relief element 188 can be used to strengthen any composite pipe connection where a rigid end connector is installed over, or otherwise constrains, a reduced length section of a composite pipe not having any manufacturing treatments or other modifications, and that is cut from a piping spool at an installation site without prior knowledge of a final cut location or final overall length.

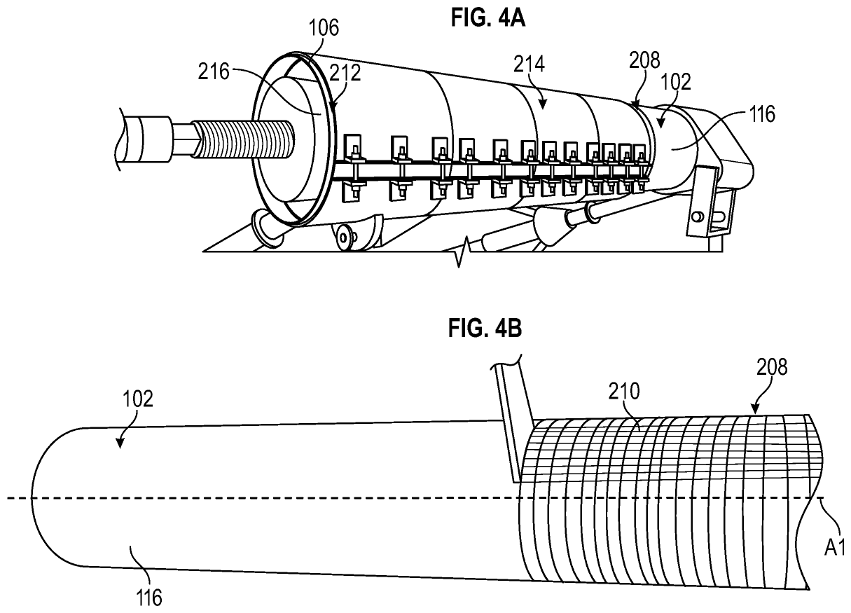

FIGS. 4A-4B illustrate side views of a composite pipe 102 including an axial reinforcement layer 208, according to one or more examples of the present disclosure. Also shown in FIG. 4B is a longitudinal axis A1, and orientation indicators Proximal and Distal. The axial reinforcement layer 208 is discussed below with reference to FIGS. 2 and 4A-4B concurrently. In FIG. 4B, the axial reinforcement layer 208 is partially cutaway to reveal reinforcement fibers 210 contained within the axial reinforcement layer 208. In some examples, the composite pipe 102 can be modified before the pipe connection 104 (FIGS. 1-3) is established to increase in the tensile load or force limit of the pipe connection 104 and increase the plastic deformation resistance of the composite pipe 102.

In contrast to existing methods of reinforcing composite piping with a high relative tensile modulus reinforcement material (HRTMRM), the axial reinforcement layer 208 can be configured for application at a pipe connection location, such as at a wellhead. For example, the axial reinforcement layer 208 can be, for example, but not limited to, one or more individual layers of tape, such as, but not limited to high-density polyethylene (HDPE) tape, various types of fiber-reinforced tape with or without an adhesive backing, fiber-reinforced sheeting or strips, perforated metallic or non-metallic tapes, sheets, or strips. In some examples, such metallic or non-metallic tape can include a three-dimensional texture, or plurality of protrusions positioned to bitingly engage the outer pipe surface 116.

In one example, the axial reinforcement layer 208 can be sized and shaped to circumferentially encompass a longitudinal length of the composite pipe 102 that is about equal to the inner slip surface 170 of the slip 108 or the outer insertion surface 158 of the mandrel 110. In other examples, the axial reinforcement layer 208 can be adapted to circumferentially encompass a longitudinal length of the composite pipe 102 that is about equal to the length L1 (FIG. 3) of the composite pipe 102 circumferentially encompassed by the strain relief element 188 (FIGS. 2-3). In additional examples, the axial reinforcement layer 208 can be adapted to circumferentially encompass other longitudinal lengths of the composite pipe 102, such as defined between the open end 106 (FIG. 4A) and a portion of the composite pipe 102 located distally to the sleeve 114 (FIGS. 1-3) or the second end 192 (FIG. 2-3) of the strain relief element 188.

In examples including the axial reinforcement layer 208, the slip 108 (FIGS. 1-2), the mandrel 110, the strain relief element 188, or other components of the pipe connection 104 can be sized and shaped to accommodate additional thickness added to the reinforcement layer 117 (FIGS. 1-2) by the axial reinforcement layer 208. The axial reinforcement layer 208 can include resilient fibers aligned, oriented, or otherwise adapted to resist the resultant force of the anticipated hoop and axial forces the composite pipe 102 is configured to carry in a restrained end or otherwise connected state, such as after the pipe connection 104 is established. For example, a majority, or all, of a plurality of the reinforcement fibers 210 contained within the axial reinforcement layer 208 can extend substantially parallel to the longitudinal axis A1. In some examples, the axial reinforcement layer 208 can additionally include resilient fibers aligned, oriented, or otherwise adapted to resist the swelling-type expansion and longitudinal extension, and the resultant force of the anticipated hoop and axial forces the composite pipe 102 is configured to carry, in an unrestrained end or otherwise unconnected state, such as during a free end test.

The axial reinforcement layer 208 can be bonded or otherwise fused to the outer pipe surface 116 (FIG. 4B), such as defined by the reinforcement layer 117, to enable a majority, or all, of the total axial load acting on the composite pipe 102 to be transferred to be carried or otherwise supported by the axial reinforcement layer 208. In one example, the axial reinforcement layer 208 can be thermally bonded to the outer pipe surface 116. For example, a longitudinal length of the composite pipe 102 can first be wrapped with a high relative tensile modulus reinforcement material (HRTMRM) to thereby locate the axial reinforcement layer 208 on the outer pipe surface 116. One or more heating elements 212 (FIG. 4A) can then be distributed about the composite pipe 102, such as to completely, or partially, encompass the axial reinforcement layer 208.

Subsequently, one or more compression clamps 214 (FIG. 4A) can be slipped over the one or more heating elements 212 and engaged or otherwise operated to compressively clamp the one or more heating elements 212 against the axial reinforcement layer 208. The one or more heating elements 212 can be, for example, but not limited to, electric or chemical heating elements. In other examples, the axial reinforcement layer can be bonded or otherwise fused to the composite pipe with other methods, such as, but not limited to, chemical bonding. The one or more compression clamps 214 can be, for example, but not limited to, screw clamps, pinch clamps, or various other styles of clamps adapted to apply a compression force to a substantially cylindrical surface.

In some examples, a brace 216 (FIG. 4A) can be inserted into the open end 106 (FIG. 4B) of the composite pipe 102 before the one or more compression clamps 214 are positioned over the axial reinforcement layer 208, such as to help prevent deformation of the inner liner 122 (FIG. 2) or delamination of the composite pipe 102 during use of the one or more heating elements 212. For example, the inner liner 122 can be more reactive, or less resistant, to thermal expansion than the reinforcement layer 117, or other layers of the composite pipe 102, and as such, the inner liner 122 can change shape, buckle, or separate from the reinforcement layer 117, or other layers of the composite pipe 102, without internal support, such as provided by the brace 216. The brace 216 can be, for example, but not limited to, a cylindrical exhaust or tailpipe expander.

In view of the above, the axial reinforcement layer 208 of the present disclosure can help to solve one or more problems found in existing composite pipe or composite pipe connections. For example, the axial reinforcement layer 208 can enable universal or otherwise multi-use spoolable composite piping to include reinforcement include resilient fibers aligned, oriented, or otherwise adapted to resist the resultant force of the anticipated hoop and axial forces when such composite piping is compressed by a rigid pipe connection. As it may be impractical for universal or multi-use composite piping to include integrated axial reinforcement material, such as in operations where an unknown length of universal or composite piping will be deployed from a piping spool, it can be appreciated that the strain relief element 188 can significantly increase the tensile load limit of the pipe connection 104, or any other composite pipe connection where compressive force is used to transfer longitudinal loads or axial stress to a rigid component of a pipe connection.

While the above description of application of the axial reinforcement layer 208 is discussed with regard to the pipe connection 104, it can be appreciated that axial reinforcement layer 208 can be applied to any existing pipe connection where compression of composite pipe transfers a tensile load to be transferred to the mechanical connector and fiber-reinforced layers of the composite pipe are not aligned or otherwise parallel to forces acting in a longitudinal or axial direction.

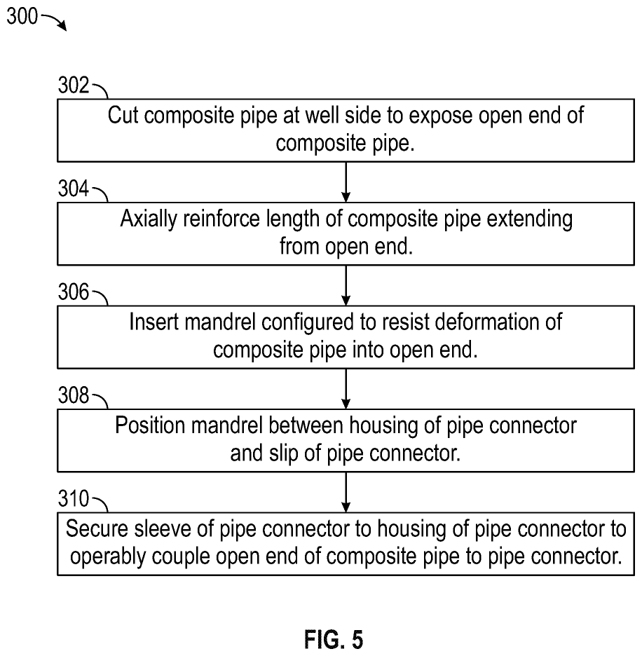

FIG. 5 illustrates a method 300 of establishing a pipe connection for connecting or terminating a composite pipe. The steps or operations of the method 300 are illustrated in a particular order for convenience and clarity; many of the discussed operations can be performed by multiple different actors, devices, or systems. It is understood that subsets of the operations discussed in the method 300 can be attributable to a single actor, device, or system and can be considered a separate standalone process or method.

The method 300 can include an operation 302. The operation 302 can include cutting the composite pipe at a connection location to expose an open end of the composite pipe. For example, after spooling out hundreds or thousands of feet of the composite pipe, such as by pulling the composite pipe with a cable pulling grip, the composite pipe can reach the connection location. In some examples, the composite pipe can be pulled to the connection location with the strain relief element 188 discussed in FIGS. 2-3 above. A user can then operate a mechanical cutting device to sever the composite pipe and expose the open end, such as to thereby prepare the composite pipe for assembly or establishment of a pipe connection.

The method 300 can include an operation 304. The operation 304 can include axially reinforcing a length of the composite pipe extending distally from the open end. For example, once the open end of the composite pipe is exposed, a user can wrap a longitudinal length of an outer pipe surface of the composite pipe with a relatively high relative tensile modulus reinforcement material, such as fiber-reinforced tape.

In some examples, the operation 304 can include compressing a heating element against the fiber-reinforced tape to thermally bond the fiber-reinforced tape to the fiber-reinforced layer. For example, after the axial reinforcement layer is located on the composite pipe, a user can distribute in one or more heating elements, such as to completely, or partially, encompass the axial reinforcement layer. Subsequently, a user can slip one or more compression clamps over the one or more heating elements and engage the one or more compressive clamps to clamp the one or more heating elements against the axial reinforcement layer.

The method 300 can include an operation 306. The operation 306 can include inserting an insertion portion of a mandrel configured to resist deformation of the composite pipe into the open end. For example, a user can push an insertion portion of the mandrel distally into an inner liner of the composite pipe until face of the mandrel contact the end of the open pipe to prevent further distal translation of the insertion portion into the composite pipe.

The method 300 can include an operation 308. The operation 308 can include positioning the mandrel between a housing and a slip. For example, a user can slide a head portion of the mandrel proximally into a housing bore of the housing; and slide a slip over the outer pipe surface of the open end. In some examples, the operation 308 can include establishing a fluid tight seal between the housing and a head portion of the mandrel and a fluid tight seal between an inner liner of the composite pipe and the insertion portion of the mandrel. For example, a user can position a first sealing element in one or more first scaling slots defined in an outer head surface of the mandrel and a second sealing element in one or more second sealing slots defined in an outer insertion surface of the mandrel.

The method 300 can include operation 310. The operation 310 can include securing a sleeve to the housing to couple the open end of the composite pipe to the pipe connection. For example, once the slip and the mandrel are positioned on or within the composite pipe, a user can move a sleeve located in a distal position along the composite pipe in a proximal direction, such as until the sleeve is positioned longitudinally over the slip the mandrel and a first coupling surface of the housing is engaged by a second coupling surface of the sleeve. In one or more examples, a user can then rotate the sleeve, such as to cause the first coupling surface to threadedly engage the second coupling surface.

In some additional examples, the method 300 can include pumping fluid through the composite pipe to cause: the slip to compress the open end of the composite pipe against the insertion portion of the mandrel with a compression force proportional to a fluid pressure within the composite pipe; and the strain relief element to compress the length of the composite pipe with a compression force based on distal translation of the open end of the composite pipe relative to the sleeve. For example, after the pipe connection is established, a user can initiate fluid flow through the composite pipe, such as from a fluid source, to cause hydraulic pressure to build between the mandrel and the slip to, in turn, drive the mandrel axially distally into the slip to compress the slip, and concurrently, cause the strain relief element to tighten around the outer pipe surface of the composite pipe.

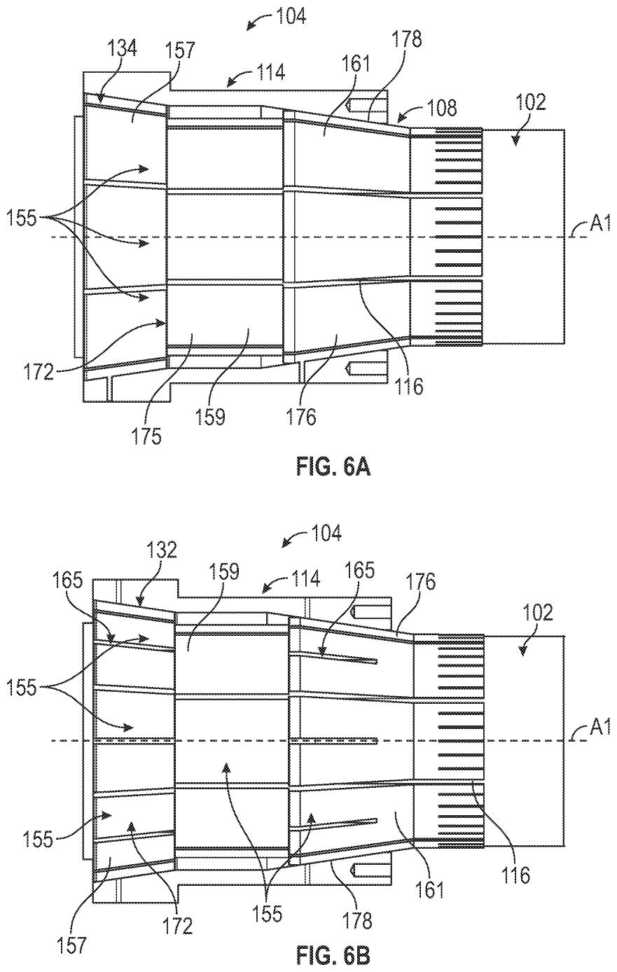

FIGS. 6A-6B illustrate cutaway views of a pipe connection 104 including a slip 108 having a plurality of segments 155, according to one or more examples of the present disclosure. FIGS. 6A-6B are discussed below concurrently. Also shown in FIGS. 6A-6B is a longitudinal axis A1. In some examples, the slip 108 can include a plurality of segments 155. The plurality of segments 155 can collectively define the slip 108. For example, each segment of the plurality of segments 155 can form a curved or semi-annular shape, such as configured to conform to a curvature, or outer diameter, of the outer pipe surface 116 of the composite pipe 102.

The plurality of segments 155 can include various numbers of segments, such as, but not limited to, two, three, or four, five, six, seven, or eight segments each defining about, but not limited to, a 180 degree, a 90 degree, a 72 degree, a 60 degree, a 51.42 degree, or a 45 degree section, respectively, of the outer slip surface 172. In one example, such as shown in FIGS. 6A-6B, each segment of the plurality of segments 155 can include a first segment 157, a second segment 159, and a third segment 161. In such an example, the first segment 157, the second segment 159, and the third segment 161 can be three of, for example, but not limited to, six, seven, or eight segments of the plurality of segments 155. The first segment 157 and the third segment 161 can each form a frustoconical shape to define the first tapered surface 134 and the second tapered surface 176, respectively, and the second segment 159 can form a cylindrical, or tubular, shape to define the cylindrical surface 175. As can be appreciated, by dividing the outer slip surface 172 into a plurality of separate radial sections, the plurality of segments 155 can help to allow the slip 108 to contract circumferentially to compressively clamp the outer pipe surface 116 of the composite pipe 102 when the slip 108 and mandrel 110 (FIG. 2) move distally relative to the housing 112 (FIG. 2) and the sleeve 114.

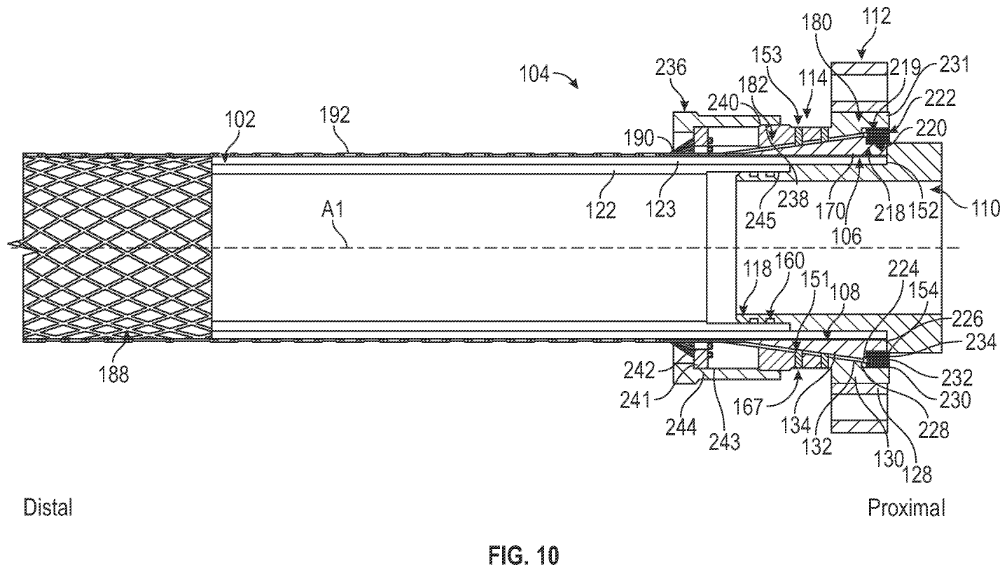

In an additional example, such as shown in FIG. 6B, each segment of the plurality of segments 155 can define a plurality of guide slots 165. The plurality of guide slots 165 can be longitudinal slots or recesses extending through the first cam surface 132 and the second cam surface 178 parallel to the first axis A1. Each guide slot of the plurality of guide slots 165 can be sized and shaped to receive a plurality of guide pins 167 (FIG. 10). The plurality of guide pins 167 can, for example, extend radially inwardly from the second cam surface 178. In other examples, the plurality of guide pins 167 can, for example, extend radially inwardly from the first cam surface 132, or both, of the first cam surface 132 and the second cam surface 178.

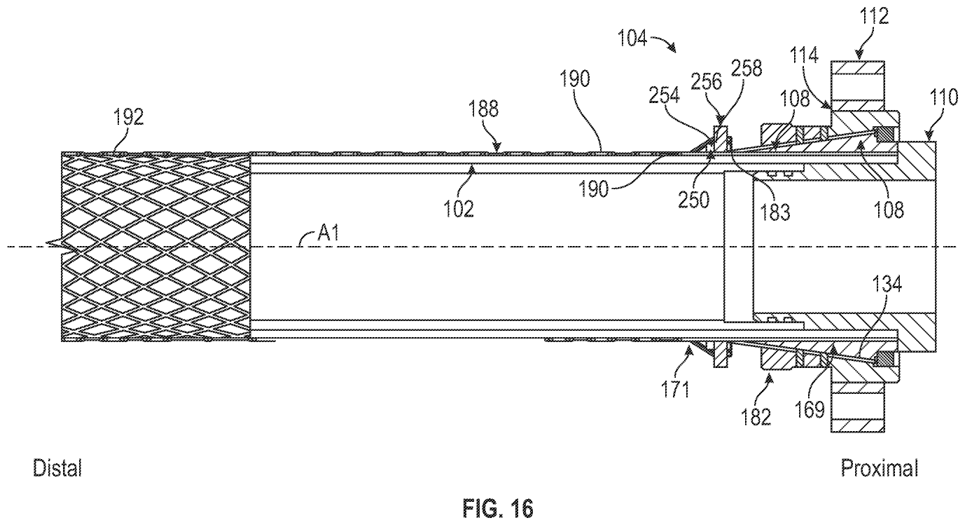

In one or more such examples, the sleeve 114 can define a plurality of guide bores 151 (FIG. 10). Each guide bore of the plurality of guide bores 151 can be adapted to receive, and retain, a guide pin of the plurality of guide pins 167. For example, the plurality of guide bores 151 and the plurality of guide pins 167 can be adapted to engage one another via a press fit, a tapered fit, or threaded engagement therebetween. Each guide bore of the plurality of guide bores 151 can extend radially through the sleeve 114 orthogonally to the longitudinal axis A1, such as between an outer sleeve surface 153 (FIG. 10) and the first cam surface 132, or, in other examples, between the outer sleeve surface 153 and the second contacting surface 404 (FIG. 16). As can be appreciated, by preventing proximal and radial movement of each slip segment of the plurality of segments 155 relative to the sleeve 114 and one another, respectively, each guide pin of the plurality of guide pins 167 and each guide slot of the plurality of guide slots 165 can ensure that each segment of the plurality of segments 155 is maintained in a position that is longitudinally and radially equidistant to other segments of the plurality of segments 155, such as during assembly or establishment of the pipe connection 104, or during subsequent use of the pipe connection.

FIG. 8 illustrates a partial cross-section of a slip 108 including a plurality of distal slits 163, according to one or more examples of the present disclosure. Also shown in FIG. 8 is a longitudinal axis A1, and orientation indicators Proximal and Distal. The slip 108 can include a first portion 169 and a second portion 171. The first portion 169 and the second portion 171 can be opposite proximal and distal portions of the slip 108, respectively. For example, the first portion 169 can include the first tapered surface 134 and the second portion 171 can include a distal slip surface 183. In other examples, such as when the slip 108 is a double taper slip, such as shown in FIGS. 1-2 and FIGS. 6A-7, the first portion 169 can include the first tapered surface 134 and the second tapered surface 176 (FIGS. 2 & 6A-6B). The first portion 169 and the second portion 171 can thereby define the outer slip surface 172 and the inner slip surface 170 (FIG. 2). In some examples, such as shown in FIG. 8, the second portion 171 can be adapted to extend distally beyond the distal portion 182 of the sleeve 114 (FIGS. 1-3) when the first portion 169 is received within the sleeve 114.

In one such example, the second portion 171 can include the plurality of distal slits 163. Each distal slit of the plurality of distal slits 163 can be a longitudinal slot or groove extending proximally along the second portion 171 parallel to, and laterally offset from, the longitudinal axis A1; and each distal slit of the plurality of distal slits can extend radially between the distal slip surface 183 of the outer slip surface 172, and the inner slip surface 170. The plurality of distal slits 163 can be distributed about a circumference of the slip 108 in a radial arrangement. For example, the plurality of distal slits 163 can include between, but not limited to, about two individual slits and about forty individual slits spaced radially equidistantly, relative to one another, around the second portion 171 of the slip 108. In some examples, when the slip 108 includes, or is collectively formed by, the plurality of segments 155, each segment of the plurality of segments 155 can include one or more individual slits of the plurality of distal slits 163. In one such example, such as shown in FIG. 8, each individual segment of the plurality of segments 155 can include four individual slits.

The plurality of distal slits 163 can help to distribute stresses that may be concentrated near, or within, the second portion 171 of the slip 108. For example, as can be appreciated in view of the all above, the second portion 171, by virtue of the plurality of distal slits 163, can less-rigidly restrain the outer pipe surface 116 (FIGS. 1-3) of the composite pipe 102 (FIGS. 1-4) than the first portion 169 of the slip 108, and the second portion 171 can, in some examples, more-rigidly restrain the composite pipe 102 than the strain relief element 188 (FIGS. 2-3) extending distally beyond the second portion 171 of the slip 108. As such, the plurality of distal slits 163 can enable the second portion 171 to provide a more gradual transition in rigidity within the pipe connection 104 (FIGS. 1-2) for the composite pipe 102, which can, in turn, increase the durability and longevity of the pipe connection 104 by helping to reduce stresses that may be concentrated within or near the pipe connection 104.

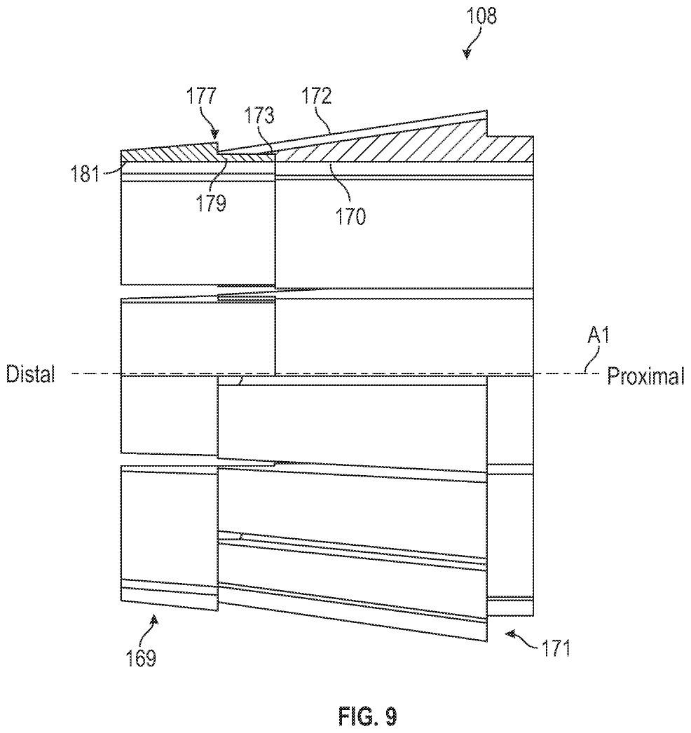

FIG. 9 illustrates a partial cross-section of a slip 108 including an annular insert 177, according to one or more examples of the present disclosure. The annular insert 177 can include a first section 179 and a second section 181. The first section 179 and the second section 181 can be opposite proximal and distal portions of the annular insert 177, respectively. In some examples, such as shown in FIG. 9, the first section 179 and the second section 181 can form a tapered, or sloped, cross-sectional shape. In other examples, the first section 179 or the second section 181 can form a cuboidal, rectangular, or otherwise non-tapered cross-sectional shape. The annular insert 177 can contact and engage the second portion 171 of the slip 108. For example, the inner slip surface 170 can include an offset portion 173 adapted to receive the first section 179 therein.

The offset portion 173 can enable the first section 179 to be compressively clamped between the inner slip surface 170 and the outer pipe surface 116 (FIGS. 1-3). In some examples, such as shown in FIG. 9, the second section 181 can form a tapered, or sloped, cross-sectional shape. In other examples, the second section 181 can form a cuboidal, rectangular, or otherwise non-tapered cross-sectional shape. The second section 181 can be adapted to extend be compressively clamped between the distal portion 182 of the sleeve 114 (FIGS. 1-3) and the outer pipe surface 116 when the sleeve 114 is secured to the housing 112 (FIGS. 1-2 & 7). The annular insert 177 can be made from a more ductile, more malleable, or otherwise more compressible and flexible material than a construction material of the slip 108 and the sleeve 114. For example, the annular insert 177 can be made from one or more non-metallic materials, such as, but not limited to, a non-metallic material including one or more of carbon fibers, glass fibers, or plastic fibers, Kevlar®, or various composite materials.

The annular insert 177 can help to distribute stresses that may be concentrated near, or within, the second portion 171 of the slip 108. For example, as the annular insert 177 can be compressively clamped against the outer pipe surface 116 (FIGS. 1-3) of the composite pipe 102 (FIGS. 1-4) between the distal portion 182 of the sleeve 114, and a portion of the inner slip surface 170 (e.g., the offset portion 173) located proximally to the distal portion 182, the annular insert 177 can provide a more gradual transition in rigidity within the pipe connection 104 (FIGS. 1-2) for the composite pipe 102. As such, the annular insert 177 can help to increase the durability and longevity of the pipe connection 104 by reducing stresses that may be concentrated near, or at, the second portion 171 of the slip 108.

FIG. 10 illustrates a cross-section of an example pipe connection 104 including a strain relief element 188 and a locking system 218. Also shown in FIG. 10 is a longitudinal axis A1, and orientation indicators Proximal and Distal. In some examples, such as shown in FIG. 7 & 10-15, the housing 112 can alternatively be adapted for extending over, or otherwise receiving, the proximal portion 180 of the sleeve 114 to secure the sleeve 114 to the housing 112, such as in contrast to the housing 112 shown in FIGS. 1-2. In one or more such examples, such as shown in FIG. 10, the first coupling surface 128 and the second coupling surface 130 can be adapted to engage each other in a manner similar to the first coupling surface 128 and the second coupling surface 130 described with reference to FIG. 2 above, except in that the first coupling surface 128 shown in FIG. 10 can extend around, or otherwise circumferentially encompass, the second coupling surface 130 shown in FIG. 10. In FIGS. 10-15, only a portion of the housing 112 defining the first coupling surface 128 is shown.

In some examples, the pipe connection 104 can include a locking system 218. The locking system 218 can be adapted to prevent, or otherwise limit, proximal movement of the slip 108 within, or relative to, the sleeve 114, such as during assembly or establishment of the pipe connection 104. In one example, such as shown in FIG. 10, the locking system 218 can include one or more set screws 219, one or more first half bores 220 defined by the slip 108, and one or more second half bores 222 defined by the sleeve 114. The one or more first half bores 220 can extend distally within the slip 108. For example, the one or more first half bores 220 can extend through the abutment surface 154 into the slip 108 parallel to, and laterally offset from, the longitudinal axis A1. In another example, the one or more first half bores 220 can extend through the abutment surface 154 into the slip 108 parallel to the first cam surface 132.

The one or more second half bores 222 can extend distally within the sleeve 114. For example, the one or more second half bores 222 can extend into the proximal portion 180 of the sleeve 114 parallel to, and laterally offset from, the longitudinal axis A1. In another example, the one or more second half bores 222 can extend into the proximal portion 180 of the sleeve 114 parallel to the first tapered surface 134. Each of the one or more first half bores 220 can be radially distributed about the slip 108, and each of the one or more second half bores 222 can be radially distributed about sleeve 114, equidistantly to one another. For example, each of the one or more first half bores 220 can be formed in a radial position that corresponds to a radial position of one of the one or more second half bores 222. As such, each first half bore of the one or more first half bores 220 and each second half bore of the one or more second half bores 222 can be aligned when the slip 108 is inserted into the sleeve 114.

The one or more set screws 219, the one or more first half bores 220, and the one or more second half bores 222 can each include various numbers of individual set screws, individual first half bores, and individual second half bores, respectively. For example, the one or more set screws 219, the one or more first half bores 220, and the one or more second half bores 222 can each include, but not limited to, one, two, three, four, five, six, seven, or eight individual set screws, individual first half bores, and individual second half bores, respectively. In some examples, such as in an example where the slip 108 includes, or is otherwise collectively formed by, the plurality of segments 155 (FIGS. 6A, 6B, and 8), the one or more set screws 219, the one or more first half bores 220, and the one or more second half bores 222 can include a number of individual set screws, individual first half bores, and individual second half bores that is proportional to a number of individual segments that the plurality of segments 155 includes.

For example, if the plurality of segments 155 includes six individual segments, such as each defining a sixty-degree section of the inner slip surface 170 and the outer slip surface 172, the one or more set screws 219 can include six set screws, the one or more first half bores 220 can include six individual first half bores, and the one or more second half bores 222 can include six individual second half bores. In such an example, each set screw of the one or more set screws 219, each first half bore of the one or more first half bores 220, and each second half bore of the one or more second half bores 222, can be radially spaced, relative to the longitudinal axis A1, by about sixty degrees circumferentially offset from one another. Each individual first half bore of the one or more first half bores 220 can define a first distal end surface 224 and a first inner surface 226.

In some examples, the first distal end surface 224 can extend orthogonally to the longitudinal axis A1 and can be distally offset from the abutment surface 154 of the slip 108; and the first inner surface 226 can extend parallel to, and laterally offset from, the longitudinal axis A1, such as, but not limited to, between the abutment surface 154 and the first distal end surface 224. In other examples, the first distal end surface 224 can extend orthogonally to the first cam surface 132, and can be distally offset from the abutment surface 154 of the slip 108; and the first inner surface 226 can extend parallel to, and laterally offset from, the first cam surface 132, such as, but not limited to, between the abutment surface 154 and the first distal end surface 224. The first distal end surface 224 can be a substantially smooth surface; or can otherwise be a curved surface defining a non-threaded profile. Each individual second half bore of the one or more second half bores 222 can define a second distal end surface 228 and a second inner surface 230.

In some examples, the second distal end surface 228 can extend orthogonally to the longitudinal axis A1 and can be distally offset from a proximal end 231 of the proximal portion 180 of the sleeve 114. In other examples, the second distal end surface 228 can extend orthogonally to the first tapered surface 134 and can be distally offset from a proximal end 231 of the proximal portion 180 of the sleeve 114, such as in an example where the one or more second half bores 222 extend parallel to the first tapered surface 134. In some examples, the second inner surface 230 can extend parallel to, and laterally offset from, the longitudinal axis A1, such as, but not limited to, between the proximal end 231 and the first distal end surface 224. In other examples, the second inner surface 230 can extend parallel to, and laterally offset from, the first tapered surface 134, such as, but not limited to, between the proximal end 231 and second distal end surface 228.

The second inner surface 230 can be a threaded surface. For example, the second inner surface 230 can define a first plurality of half threads 232. The first plurality of half threads 232 can be adapted to threadedly engage a second plurality of threads 234 defined by each set screw of the one or more set screws 219. For example, during assembly or establishment of the pipe connection 104, the sleeve 114 can be moved proximally along the composite pipe 102 and over the slip 108 to radially, and longitudinally, align each first half bore of the one or more first half bores 220 and each second half bore of the one or more second half bores 222. Next, each set screw of the one or more set screws 219 can be inserted into each second half bore of the one or more second half bores 222 and each first half bore of the one or more first half bores 220 to, in turn, draw the slip 108 distally into the sleeve 114 by virtue of rotation of the second plurality of threads 234 within the first plurality of half threads 232.

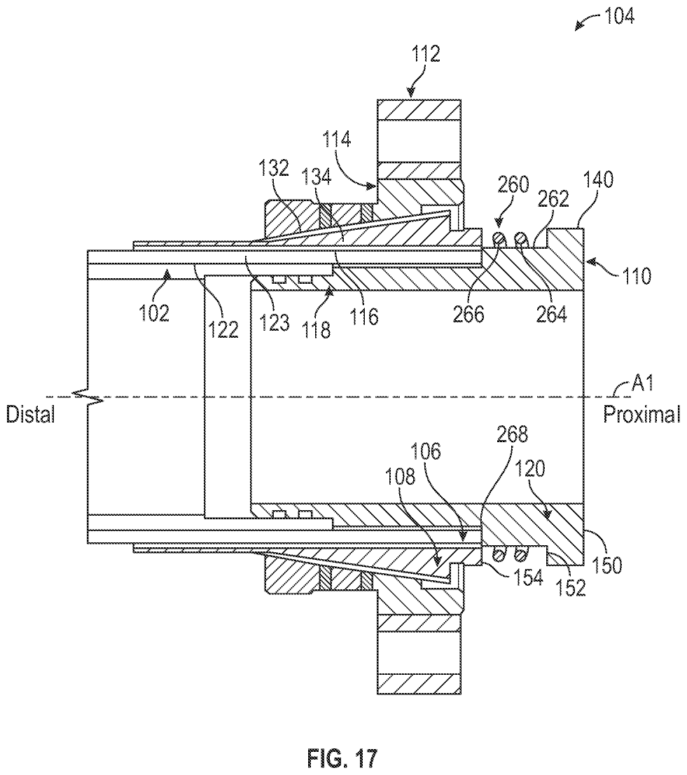

Each set screw of the one or more set screws 219 can be rotated within each first half bore of the one or more first half bores 220 and each second half bore of the one or more second half bores until each set screw of the one or more set screws 219 contacts one, or both, of the first distal end surface 224 or the second distal end surface 228. Subsequently, when fluid pressure builds between the slip 108 and the mandrel 110, or the mandrel 110 is biased distally by other means, such as the longitudinal spring 260 (FIG. 17), to drive the slip 108 distally within the sleeve 114, the non-threaded nature of each first half bore of the one or more first half bores 220 can enable each set screw of the one or more set screws 219 to slide distally along the first inner surface 226, to thereby allow the first tapered surface 134 to slide along the first cam surface 132 and compress the inner slip surface 170 into the composite pipe 102. In view of the above, the locking system 218 can allow for distal translation of the slip 108 within the sleeve 114, such as in response to a distal force acting on the mandrel 110; and prevent proximal translation of the slip 108 within the sleeve 114, such as in response to a proximal force acting on the slip 108 or the composite pipe 102.

In some examples, such as shown in FIG. 10, the first end 190 of the strain relief element 188 can be restrained by a nut 236, such as in examples where the distal portion 182 of the sleeve 114 does not include the flange 198 (FIGS. 2-3) to secure the first end 190 of the strain relief element 188 to the distal portion 182 of the sleeve 114. The nut 236 can be adapted to encompass, or otherwise receive, the distal portion 182 of the sleeve 114 to secure the nut 236 to the sleeve 114. For example, the distal portion 182 of the sleeve 114 can define a first series of threads 238 and the nut 236 can define a second series of threads 240. The first series of threads 238 can be defined about an inner circumference of the nut 236 and the second series of threads 240 can be defined about an outer circumference of the distal portion 182. The first series of threads 238 can be adapted to threadedly engage the second series of threads 240 to adjust a longitudinal position of the nut 236 relative to the sleeve 114 and the longitudinal axis A1.

The nut 236 can be made from various materials, such as, but not limited to, can be made from hardened steel, metal alloys adapted for strength and/or corrosion resistance, coated metals (e.g., nickel, epoxy, etc.), stainless steel, corrosion resistant and/or sour resistant alloys, austenitic nickel-chromium-based superalloys such as Inconel®, and/or high chrome. In other examples, the slip 108, the mandrel 110, the housing 112, the sleeve 114, or other components of the pipe connection 104, can be made from one or more non-metallic materials, such as, but not limited to, such as, but not limited to, materials including carbon fibers, glass fibers, or plastic fibers, Kevlar®, or various composite materials.

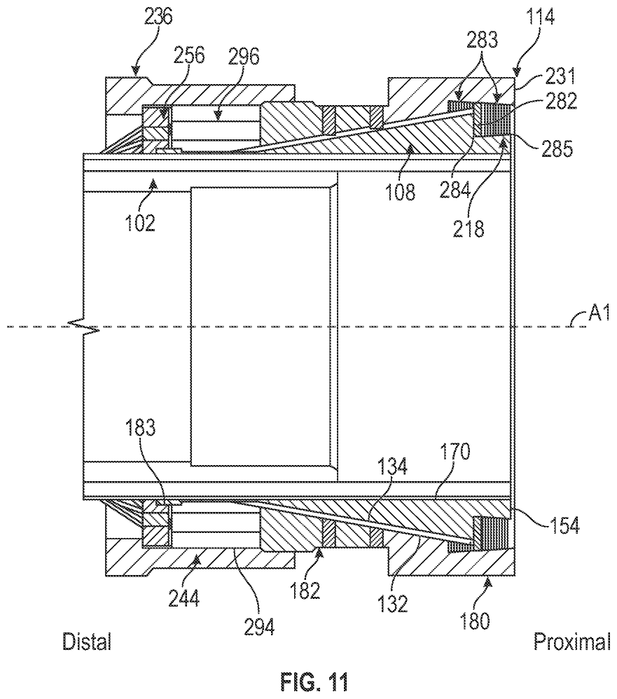

The nut 236 can be adapted to retain the first end 190 of the strain relief element 188. For example, the nut 236 can include an inner portion 242 extending radially inwardly from an outer portion 244 including the second series of the threads 240. The first end 190 of the strain relief element 188 can be anchored to the inner portion 242 by various means. For example, the first end 190 can be secured to, or the plurality of tabs 194 (FIG. 2) of the first end 190 can be secured to, the inner portion 242 via one or more threaded or non-threaded fasteners, such as extending directly through the first end 190, or directly through the plurality of tabs 194 into, or through, the inner portion 242 of the nut 236. In another example, the first end 190, or the plurality of tabs 194 of the first end 190, can be compressively clamped between two opposing surfaces of the nut 236, such as, but not limited to, between a first opposing surface 241 of the inner portion 242 and a second opposing surface 243 of the outer portion 244. In further examples, the first end 190 can be secured to a retaining ring 256 (FIGS. 11, 12, 13A-13B, & 16), such as encompassed and restrained by the nut 236.

When the first end 190 is secured to the nut 236, the nut 236 can be rotated to increase, or decrease, the compression force applied to the composite pipe 102 by the strain relief element 188. For example, the nut 236 can be rotated in a first, or clockwise, direction about the longitudinal axis A1 to move the nut 236 proximally along the distal portion 182 of the sleeve 114, to in turn increase the longitudinal distance L2 (FIG. 3) between the second end 192 or the one or more clamps 207 (FIG. 3) securing the second end 192 to the composite pipe 102. In response, the strain relief element 188 can decrease in diameter, to thereby frictionally engage and compress, the length L1 (FIG. 3) of the composite pipe 102 encompassed by the strain relief element 188 with an increased compression force. Similarly, the nut 236 can be rotated in a second, or clockwise, direction about the longitudinal axis A1 to move the nut 236 distally along the distal portion 182 of the sleeve 114, to in turn decrease the longitudinal distance L2 between the second end 192 or the one or more clamps 207 (FIG. 3) securing the second end 192 to the composite pipe 102.

In response, the strain relief element 188 can increase in diameter to, and thereby, the length L1 (FIG. 3) of the composite pipe 102 encompassed by the strain relief element 188 with a decreased compression force. In view of the above, the nut 236 can enable a user to conveniently and precisely adjust the compression force applied to the composite pipe 102 by the strain relief element 188, such as based on one or more material properties of the composite pipe 102 or the pipe connection 104, an internal pressure within the composite pipe 102, ambient temperature, or other operational factors.

In some examples, such as shown in FIG. 10, an entire thickness of the inner liner 122 within the open end 106, such as including one or more individual layers of the inner liner 122, can be removed during assembly or establishment of the pipe connection 104. In other examples, an entire thickness of the inner liner 122 and a portion of a thickness of an outer liner 123 encompassing the inner liner 122, or other outer layers of the composite pipe 102 encompassing the outer liner 123, such as an abrasion resistant outer jacket, can be removed during assembly or establishment of the pipe connection 104. For example, prior to insertion of the insertion portion 118 of the mandrel 110 into the open end 106, the inner liner 122 can be reamed, or otherwise shaped, to define a cutaway portion 245, and an abrasion resistance outer jacket or cover encompassing the outer liner 123 or the reinforcement layer 117 (FIGS. 1-2), can be removed. The cutaway portion 245 can generally be a length of the composite pipe 102 where a thickness of the inner liner 122 is completely removed, and a thickness of the outer liner 123 is partially or completely intact. In such examples, the outer insertion surface 158 (FIG. 2), such as, but not limited to, a portion thereof extending proximally to the one or more second sealing slots 160, can be sized and shaped to contact and engage the outer liner 123.

The cutaway portion 245 can generally be a length of the composite pipe 102 where a thickness of the inner liner 122 is completely removed, and a thickness of the outer liner 123 is partially or completely intact. As can be appreciated, by removing the inner liner 122 from contact with the outer insertion surface 158 within the open end 106, a volume of relatively flowable or compressible material that can flow or can otherwise be displaced before the mandrel 110 begins to engage one or more less flowable or compressible layers of the composite pipe 102, such as one or more layers of the reinforcement layer 117 (FIGS. 1-2) or the outer liner 123, can be reduced. In view of the above, the cutaway portion 245 can help to increase the durability and longevity of the pipe connection 104, as pipe connections can fail due a reduction in tensile load (e.g., force) carrying capacity as a result of plastic deformation (e.g., plastic flow, plastic creep, or thermal ratcheting).

FIG. 11 illustrates a cross-section of an example pipe connection 104 including a locking system 218. Also shown in FIG. 11 is a longitudinal axis A1, and orientation indicators Proximal and Distal. The locking system 218 can be adapted to prevent, or otherwise limit, proximal movement of the slip 108 within or relative to the sleeve 114, such as during assembly or establishment of the pipe connection 104. In some examples, such as shown in FIG. 11, and alternatively to as described with regard to FIG. 10, the locking system 218 can include an internal ring 282, a series of concentric grooves 283 defined by the proximal portion 180 of the sleeve 114, and a distal end surface 284 and an inner surface 285 defined by the slip 108. The internal ring 282 can be, for example, but not limited to, a circumferentially compressible split ring or snap ring.

The series of concentric grooves 283 can extend distally within the sleeve 114 concentrically with one another and the longitudinal axis A1; and can consecutively or progressively increase in diameter in a distal direction between the proximal end 231 of the sleeve 114 and an inner end surface 289 of the sleeve 114. The series of concentric grooves 283 can include various numbers of individual bores, such as, but not limited to, eight, nine, ten, eleven, twelve, thirteen, fourteen, or fifteen individual bores. The distal end surface 284 can extend orthogonally to the longitudinal axis A1 and can be distally offset from the abutment surface 154 of the slip 108; and the inner surface 285 can extend parallel to, and laterally offset from, the longitudinal axis A1, such as, but not limited to, between the abutment surface 154 and the distal end surface 284.

The internal ring 282 can be adapted to contact and engage the sleeve 114 within the series of concentric grooves 283. For example, during assembly or establishment of the pipe connection 104, the sleeve 114 can be moved proximally along the composite pipe 102 and over the slip 108 to align the distal end surface 284 with one of the series of concentric grooves 283 or the inner end surface 289. Next, the internal ring 282 can be circumferentially compressed and inserted into the sleeve 114 in a distal direction along longitudinal axis A 1, such as until the internal ring 282 contacts the distal end surface 284 of the slip 108 and is received within one of the series of concentric grooves 283, to thereby prevent the slip 108 from moving in a proximal direction along the longitudinal axis A1.

Subsequently, when fluid pressure builds between the slip 108 and the mandrel 110 (FIG. 10), or the mandrel 110 is biased distally by other means, such as the longitudinal spring 260 (FIG. 17), to drive the slip 108 distally within the sleeve 114, the inner surface 285 of the slip 108 can slide distally within the internal ring 282 to thereby enable the first tapered surface 134 to slide along the first cam surface 132 and compress the inner slip surface 170 into the composite pipe 102. In view of the above, the locking system 218 shown in FIG. 11 can allow for distal translation of the slip 108 within the sleeve 114, such as in response to a distal force acting on the mandrel 110; and prevent proximal translation of the slip 108 within the sleeve 114, such as in response to a proximal force acting on the slip 108 or the composite pipe 102.

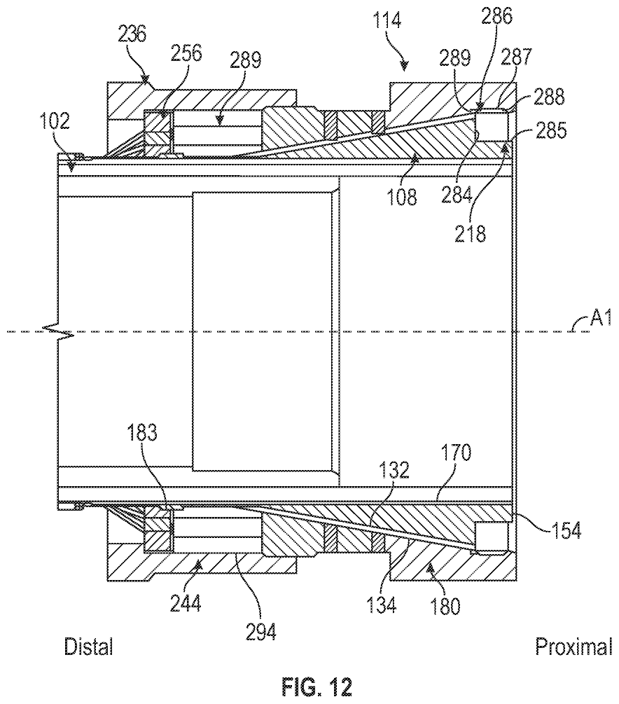

FIG. 12 illustrates a cross-section of an example pipe connection 104 including a locking system 218. Also shown in FIG. 12 is a longitudinal axis A1, and orientation indicators Proximal and Distal. In a still further example, such as shown in FIG. 12, and alternatively to as described with regard to FIGS. 10-11, the locking system 218 can include a threaded ring 286, an inner series of threads 287 defined by the proximal portion 180 of the sleeve 114, and the distal end surface 284 and the inner surface 285 defined by the slip 108. The threaded ring 286 can be, for example, a solid ring defining an outer series of threads 288 about an outer circumference or surface thereof. The inner series of threads 287 can extend distally within the sleeve 114 and concentrically with longitudinal axis A1. The inner series of threads 287 can be adapted to threadedly engage the outer series of threads 288 of the threaded ring 286 to secure the threaded ring 286 within the sleeve 114. For example, during assembly or establishment of the pipe connection 104, the sleeve 114 can be moved proximally along the composite pipe 102 and over the slip 108, such as until the distal end surface 284 is aligned with the inner end surface 289 or the inner series of threads 287.

The threaded ring 286 can then be inserted distally into the sleeve 114 along longitudinal axis A1 and over the inner surface 285 of the slip 108, such as by aligning the threaded ring 286 within the abutment surface 154 of the slip 108. Next, the threaded ring 286 can be rotated within the sleeve 114 to, in turn, draw the slip 108 distally into the sleeve 114 along the longitudinal axis A1 by virtue of rotation of the outer series of threads 288 within the inner series of threads 287, until the threaded ring 286 contacts one or both of the distal end surface 284 of the slip 108 or the inner end surface 289 of the sleeve 114 to thereby prevent the slip 108 from moving in a proximal direction along the longitudinal axis A1.

Subsequently, when fluid pressure builds between the slip 108 and the mandrel 110 (FIG. 10), or the mandrel 110 is biased distally by other means, such as the longitudinal spring 260 (FIG. 17), to drive the slip 108 distally within the sleeve 114, the non-threaded nature of the surface engagement between the inner surface 285 of the slip 108 and the threaded ring 286 can enable the slip 108 to slide distally within the threaded ring 286, to thereby allow the first tapered surface 134 to slide along the first cam surface 132 and compress the inner slip surface 170 into the composite pipe 102. In view of the above, the locking system 218 shown in FIG. 12 can allow for distal translation of the slip 108 within the sleeve 114, such as in response to a distal force acting on the mandrel 110, and prevent proximal translation of the slip 108 within the sleeve 114, such as in response to a proximal force acting on the slip 108 or the composite pipe 102.

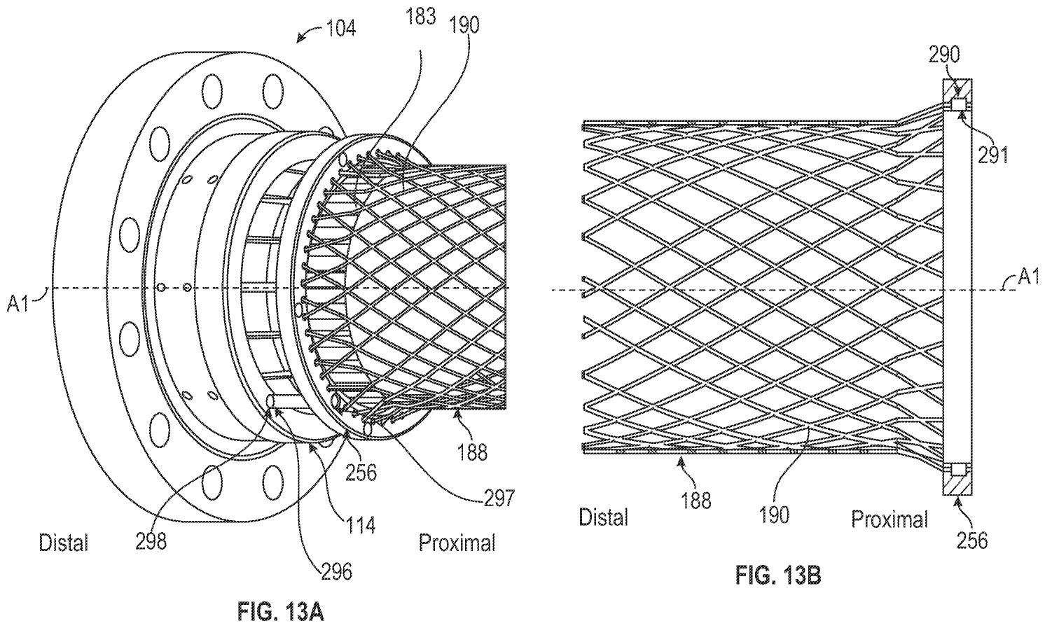

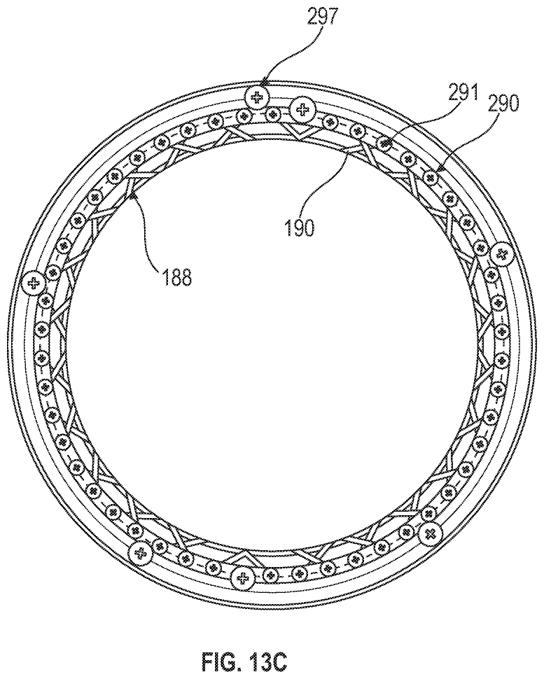

FIG. 13A illustrates a side view of an example pipe connection 104 including a strain relief element 188, according to one or more examples of the present disclosure. FIG. 13B illustrates a side view of an example retaining ring 256 and the strain relief element 188, according to one or more examples of the present disclosure. FIG. 13C illustrates a front view of an example retaining ring 256, according to one or more examples of the present disclosure. Also shown in FIGS. 13A-13B is a longitudinal axis A1, and orientation indicators Proximal and Distal. FIGS. 13A-13C are discussed below concurrently. In some examples, the retaining ring 256 can define a plurality of pockets 290. Each of the plurality of pockets 290 can be a bore or recess extending distally into the retaining ring 256, such as, but not limited to, parallel to and laterally offset from the longitudinal axis A1.

In some examples, the first end 190 of the strain relief element 188 can include a plurality of end stops 291 (FIGS. 13B-13C). Each of the plurality of end stops 291 can be crimped, or otherwise connected to, an individual cable or strand of the strain relief element 188. As such, the plurality of end stops 291 can be distributed in a radial or annular arrangement about the first end 190, and the number of individual end stops the plurality of end stops 291 includes can be directly proportional to the number of individual cables or strands the strain relief element 188 includes. The plurality of end stops 291 can be configured to enable the first end 190 of the strain relief element 188 to be secured to the retaining ring 256. For example, each of the plurality of end stops 291 can define a rectangular, cuboidal, or cylindrical three-dimensional shape adapted to be received within, or otherwise correspond to, each pocket of the plurality of pockets 290.

In the operation of such examples, each individual cable or strand of the first end 190 can be passed proximally through the retaining ring 256 via each pocket of the plurality of pockets 290, and then crimped or otherwise secured to an individual end stop of the plurality of end stops 291. Subsequently, the strain relief element 188 can be moved in a distal direction to cause each of the plurality of end stops 291 to enter into an individual pocket of the plurality of pockets 290 to thereby secure the first end 190 to the retaining ring 256. In some such examples, the retaining ring 256 can be circumferentially encompassed and restrained by the nut 236, such as shown in FIGS. 11-12. For example, the retaining ring 256 can be sized and shaped to concurrently contact and engage one of the distal slip surface 183 (FIGS. 11-12 & 13A) or an inner nut surface 294 (FIGS. 11-12) of the outer portion 244 (FIGS. 11-12) of the nut 236. In one such example, such as in an example where the retaining ring 256 is adapted to engage the inner nut surface 294, rotation of the nut 236 can cause the retaining ring 256 to slide proximally or distally along the distal slip surface 183 (FIGS. 8 & 11-12) of the slip 108 to increase, or decrease, the compression force applied to the composite pipe 102 by the strain relief element 188.

In some examples, such as shown in FIGS. 11-12 and 13A, the pipe connection 104 can include one or more pins 296. In such examples, the retaining ring 256 can define one or more first pin bores 297 (FIGS. 13A & 13C) and the distal portion 182 of the sleeve 114 can include a one or more second pin bores 298 (FIG. 13A). Each bore of the one or more first pin bores 297 and each bore of the one or more second pin bores 298 can be configured to receive at least a portion of a pin of the one or more pins 296. The one or more first pin bores 297 can extend distally into the retaining ring 256, such as parallel to and laterally offset from the longitudinal axis A1. The one or more second pin bores 298 can extend proximally into the sleeve 114, such as, but not limited to, parallel to and laterally offset from the longitudinal axis A1. The one or more first pin bores 297 and the one or more second pin bores 298 can be located about the sleeve 114 and the retaining ring 256, respectively, in a radial or an annular arrangement.

The one or more first pin bores 297 can be formed in corresponding radial positions relative to one or more second pin bores 298, such as to enable each pin bore of the one or more first pin bores 297 and each pin bore of the one or more second pin bores 298 to be aligned, to thereby enable one pin of the one or more pins 296 to be inserted into, or received within, one pin bore of the one or more first pin bores 297 and one pin bore of the one or more second pin bores 298 concurrently. As can be appreciated in view of the above, the one or more pins 296, the one or more first pin bores 297, and the one or more second pin bores 298 can prevent relative rotation between the retaining ring 256, and thereby the first end 190 of the strain relief element 188, and the sleeve 114.

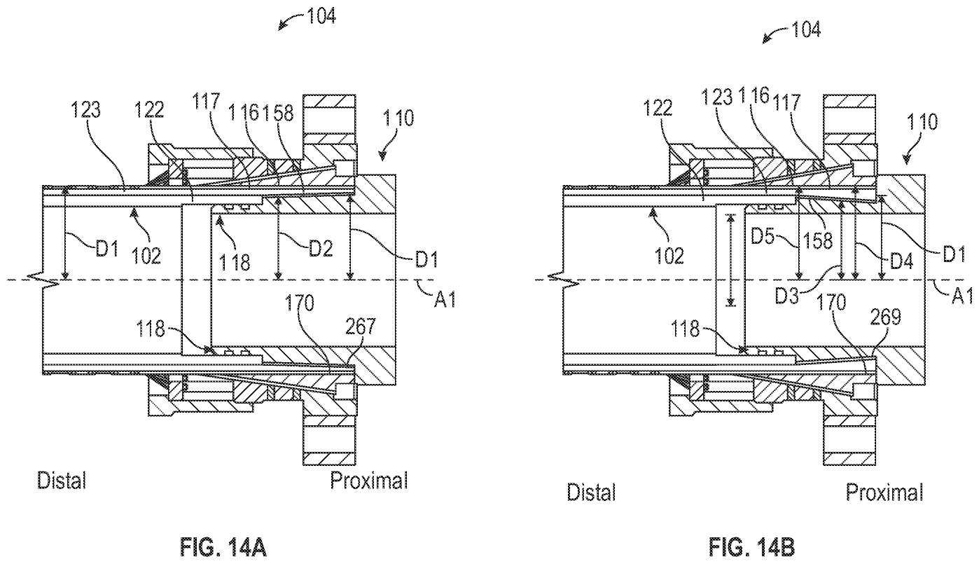

FIG. 14A illustrates an example pipe connection 104, according to one or more examples of the present disclosure. Also shown in FIG. 14A and FIG. 14B is a longitudinal axis A1, and orientation indicators Proximal and Distal. FIGS. 14A-14B are discussed below concurrently. In some examples, such as shown in FIG. 14A, the insertion portion 118 of the mandrel 110 can form a male, or forward, taper. For example, a distance D1 measured between the longitudinal axis A1 and a point along the outer insertion surface 158 proximal to, or otherwise near, the head portion 120 (FIG. 2) can be greater than a distance D2 (FIG. 14A) measured between a point along the outer insertion surface 158 located distally to the point at which the first distance D1 is measured.

In such an example, during assembly or establishment of pipe connection 104, the inner liner 122 can be reamed, or otherwise shaped, to define a first sloped surface 267 that corresponds to the slope or taper of the outer insertion surface 158, such as by defining a corresponding female, or reverse, taper. In other examples, the inner liner 122 can alternatively be reamed, or otherwise shaped, to reduce the diameter of the inner liner to allow the composite pipe 102 to deform into a tapered or sloped profile when the composite pipe is compressively clamped between the outer insertion surface 158 and the correspondingly tapered slips. As can be appreciated, such tapered engagement between the insertion portion 118 and the inner liner 122 can help the pipe connection 104 resist movement of the composite pipe 102 relative to the mandrel 110 and the slip 108, such as independently of, or in addition to, the one or more pipe-engaging features 174 (FIG. 2) of the inner slip surface 170 and the outer insertion surface 158.

In some examples, such as shown in FIG. 14B, the insertion portion 118 of the mandrel 110 can form a female, or reverse, taper. For example, the distance D1 measured between the longitudinal axis A1 and a point along the outer insertion surface 158 proximal to, or otherwise near, the head portion 120 can be less than a distance D3 (FIG. 14B) measured between a point along the outer insertion surface 158 located distally to the point at which the first distance D1 is measured. In such an example, during assembly or establishment of the pipe connection 104, the inner liner 122 can be reamed, or otherwise shaped, to define a second sloped surface 269 that corresponds to the slope or taper of the outer insertion surface 158, such as by defining a corresponding male, or forward, taper. As can be appreciated, such tapered engagement between the insertion portion 118 and the inner liner 122 can help the pipe connection 104 to resist movement of the composite pipe 102 relative to the mandrel 110 and the slip 108, such as independently of, or in addition to, the one or more pipe-engaging features 174 of the inner slip surface 170 and the outer insertion surface 158.

In either of the above examples, the outer insertion surface 158, and the first sloped surface 267 or the second sloped surface 269, can each extend at an angle of, but not limited to, between about 0 degrees to about 10 degrees relative to the longitudinal axis A1. In further examples, the open end 106, such as including the reinforcement layer 117 or the outer liner 123, the inner liner 122, and the inner slip surface 170, can also be reamed or shaped to define a male, or female, taper. For example, a distance D4 (FIG. 14B) measured between the longitudinal axis A1 and a point along the outer pipe surface 116 located proximal to, or otherwise near, the head portion 120, can be greater than, or less, than a distance D5 (FIG. 14A) measured between the longitudinal axis A1 and a point along the outer pipe surface 116 located distally to the point at which the distance D4 is measured. As can be appreciated, in view of all the above, if the outer insertion surface 158 and the inner slip surface 170 each define a male or forward taper, the open end 106 can define a female taper; and, conversely, if open end 106 defines a male or forward taper, the outer insertion surface 158 and the inner slip surface 170 can define a female, or reverse, taper.

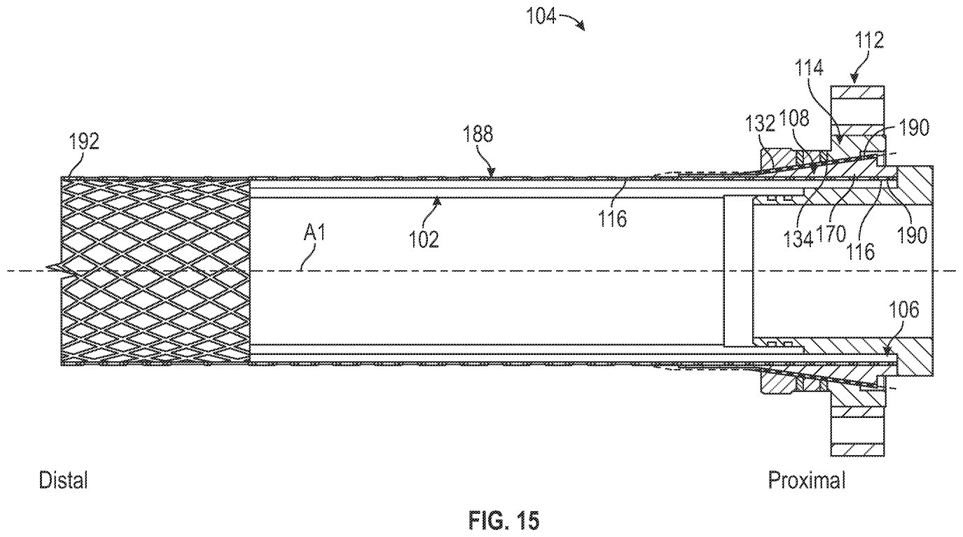

FIG. 15 illustrates an example pipe connection 104 including a strain relief element 188, according to one or more examples of the present disclosure. Also shown in FIG. 15 is a longitudinal axis A1, and orientation indicators Proximal and Distal. In some examples, such as when the first end 190 of the strain relief element 188 is not secured directly to the sleeve 114, to the nut 236 (FIGS. 10-12), or to the slip 108, the first end 190 can be compressively clamped between the first tapered surface 134 and first cam surface 132 when the sleeve 114 is secured to the housing 112. For example, during assembly or establishment of the pipe connection 104, the sleeve 114 can first be positioned over the open end 106 of the composite pipe 102, and then the sleeve 114 can be moved in a distal direction over the first end 190 of the strain relief element 188. Next, the slip 108 can be slipped over the open end 106, and the first end 190 of the strain relief element 188 can be moved proximally over the first tapered surface 134 of the slip 108. Subsequently, the sleeve 114 can be moved proximally over the first end 190 of the strain relief element 188 and the first tapered surface 134 of the slip 108, and then secured to the housing 112 to hereby cause the first cam surface 132 to compressively clamp the first end 190 against the first tapered surface 134.

In other examples, such as when the first end 190 of the strain relief element 188 is not secured directly to the sleeve 114, to the nut 236, or to the slip 108, the first end 190 can be compressively clamped between the inner slip surface 170 and an outer pipe surface 116 of the composite pipe 102. For example, during assembly or establishment of the pipe connection 104, the sleeve 114 can first be positioned over the open end 106 of the composite pipe 102, and then the sleeve 114 moved in a distal direction over the first end 190 of the strain relief element 188. Next, the first end 190 of the strain relief element 188 can be moved proximally along the composite pipe 102 until the first end 190 is located over, or aligned with, the open end 106, and then the slip 108 can be slipped over both the first end 190 and the open end 106. Subsequently, the sleeve 114 can be moved proximally over the first tapered surface 134 of the slip 108, and then secured to the housing 112 to cause the inner slip surface 170 to compressively clamp the first end 190 against the outer pipe surface 116.

FIG. 16 illustrates an example pipe connection 104 including a strain relief element 188 secured to a slip 108, according to one or more examples of the present disclosure. Also shown in FIG. 16 is a longitudinal axis A1, and orientation indicators Proximal and Distal. In some examples, such as shown in FIG. 16, the first end 190 of the strain relief element 188 can be anchored to the second portion 171 of the slip 108, such as in examples where the distal portion 182 of the sleeve 114 does not include the flange 198 (FIGS. 2-3) to secure the first end 190 of the strain relief element 188 to the sleeve 114. In such examples, the distal slip surface 183 of the second portion 171 can extend distally beyond the distal portion 182 of the sleeve 114, when the first portion 169 of the slip 108 including the first tapered surface 134 is received within the sleeve 114; and the distal slip surface 183 can define a projection 250.

The projection 250 can generally be a portion of the distal slip surface 183 forming a radial or annular protrusion. In some such examples, the first end 190 of the strain relief element 188 can be anchored directly to the projection 250 by various means. For example, the first end 190 can be secured to, or the plurality of tabs 194 (FIG. 2) of the first end 190 can be secured to, the projection 250 via one or more threaded or non-threaded fasteners, such as extending directly through the first end 190, or directly through the plurality of tabs 194 into, or through, the projection 250 of the slip. In another example, the first end 190, or the plurality of tabs 194 of the first end 190, can be compressively clamped between two opposing surfaces of the slip 108, such as, but not limited to, between a distal opposing surface 254 of the retaining ring 256 and a proximal opposing surface 258 of the projection 250.

In further examples, such as shown in FIG. 16, the first end 190 can be secured to, or the plurality of tabs 194 (FIG. 2) of the first end 190 can be secured to, the retaining ring 256 via one or more threaded or non-threaded fasteners, such as extending directly through the first end 190, or directly through the plurality of tabs 194 into, or through, the retaining ring 256 of the slip 108. In such examples, the projection 250 can be adapted to prevent distal movement or translation of the retaining ring 256 along the longitudinal axis A1. For example, the retaining ring 256 can be adapted to engage the distal slip surface 183 in longitudinal position that is proximal, and adjacent to, the projection 250, or the retaining ring 256 and the projection 250 can be adapted to engage one another via one or more threaded or non-threaded fasteners extending radially or longitudinally there through.

In an additional example, the retaining ring 256 can be a threaded nut or body, such as sized and shaped similarly to the nut 236 (FIGS. 10-12) and including a first series of threads; and the projection 250 can be threaded protrusion of the slip 108, such as sized and shaped similarly to the distal portion 182 of the sleeve and including a second series threads adapted to threadedly engage the first series of threads of the retaining ring 256. As can be appreciated, in such an example, the retaining ring 256 and the projection 250 can enable a user to conveniently and precisely adjust the compression force applied to the composite pipe 102 by the strain relief element 188, such as based on one or more material properties of the composite pipe 102 or the pipe connection 104, an internal pressure within the composite pipe 102, ambient temperature, or other operational factors.

FIG. 17 illustrates an example pipe connection 104 including a longitudinal spring 260, according to one or more examples of the present disclosure. Also shown in FIG. 17 is a longitudinal axis A1, and orientation indicators Proximal and Distal. In some examples, the pipe connection 104 can include a longitudinal spring 260, which can be, for example, but is not limited to, a single or multi-rate compression spring; and the head portion 120 of the mandrel 110 can define a proximal annular surface 262. The proximal annular surface 262 can longitudinally space the second surface 152 of the head portion 120 apart from the abutment surface 154 of the slip 108. For example, the proximal annular surface 262 can extend longitudinally between the second surface 152 of the mandrel 110 and the abutment surface 154 of the slip 108, such as parallel to, and laterally offset form, the outer head surface 140.

The proximal annular surface 262 can define a substantially smooth profile; and can define a diameter less than a diameter defined by the outer head surface 140 extending between the second surface 152 and the first surface 150 of the head portion 120. The longitudinal spring 260 can define a proximal end 264 and a distal end 266. The proximal end 264 and the distal end 266 can be opposite proximal and distal portions of the longitudinal spring 260, respectively. The longitudinal spring 260 can be made from various materials, such as, but not limited to, can be made from hardened steel, metal alloys adapted for strength and/or corrosion resistance, coated metals (e.g., nickel, epoxy, etc.), stainless steel, corrosion resistant and/or sour resistant alloys, austenitic nickel-chromium-based superalloys such as Inconel®, and/or high chrome.

The longitudinal spring 260 can be adapted to be received about, or otherwise encompass, the proximal annular surface 262 of the head portion 120. For example, during assembly or establishment of the pipe connection 104, the longitudinal spring 260 can be slipped over the outer insertion surface 158 of the insertion portion and moved proximally along the proximal annular surface 262 until the proximal end 264 of the longitudinal spring 260 contacts the second surface 152 of the head portion 120. Next, the mandrel 110 can be inserted into the open end 106 of the composite pipe 102 until distal end 266 of the longitudinal spring 260 contacts the abutment surface 154. Subsequently, the sleeve 114 can be secured to the housing 112 to longitudinally compress the longitudinal spring 260. For example, as the sleeve 114 is secured to the housing 112, the end surface 124 (FIG. 2) of the housing 112 can contact and drive the first surface 150 of the mandrel 110 distally, such as until a distal annular surface 268 of the head portion 120 contacts the open end 106. When the longitudinal spring 260 is compressed between the abutment surface of the slip 108 and the second surface 152 of the head portion 120, the longitudinal spring 260 can cause the slip 108 to compress the composite pipe 102 against the insertion portion 118, such with a compression force that is proportional to a compression force of, or otherwise contained within, the longitudinal spring 260. For example, when the sleeve 114 is secured to the housing 112, the longitudinal spring 260 can bias or drive the slip 108 distally within the sleeve 114 to cause the first cam surface 132 to slide along the first tapered surface 134 to compress the slip 108 into engagement with the outer pipe surface 116; and, in turn, compress the inner liner 122, the outer liner 123, or any other layers of the composite pipe 102 against the outer insertion surface 158 of the insertion portion 118.

In view of the above, the longitudinal spring 260 can enable the pipe connection 104 to provide an additional compression force to the composite pipe 102, such as beyond, or greater than, the fixed compression force, or initial preload, provided by the sleeve 114 to the slip 108 when the sleeve 114 is secured to the housing 112. Moreover, as the longitudinal spring 260 can cause the slip 108 to translate distally within the sleeve 114, such as in response to plastic deformation, shrinkage, or other physical changes of the composite pipe 102, the longitudinal spring 260 can enable the pipe connection 104 to compress the composite pipe 102 with a consistent and continuous compression force that is not reduced or decreased by physical changes of the composite pipe 102. Therefore, the longitudinal spring 260 can increase the tensile load carrying capacity of the pipe connection 104, such as relative to existing composite pipe connections that engage a composite pipe with a fixed initial preload or compression force.

In some examples, the longitudinal spring 260 can be used as a supplementary method, in addition to the use of fluid pressure between the mandrel 110 and the slip 108, of providing an additional compression force to the composite pipe 102 beyond the fixed compression force or initial preload provided by the sleeve 114 to the slip 108 when the sleeve 114 is secured to the housing 112. In other examples, the longitudinal spring 260 can be used as an alternative method, such as alternatively to the use of fluid pressure between the mandrel 110 and the slip 108, of providing an additional compression force to the composite pipe 102 beyond the fixed compression force or initial preload provided by the sleeve 114 to the slip 108 when the sleeve 114 is secured to the housing 112. In such examples, it can be appreciated that the head portion 120 may not include the one or more first sealing slots 142 (FIG. 2) and the head portion 120 may not be configured to translate axially within the housing 112.

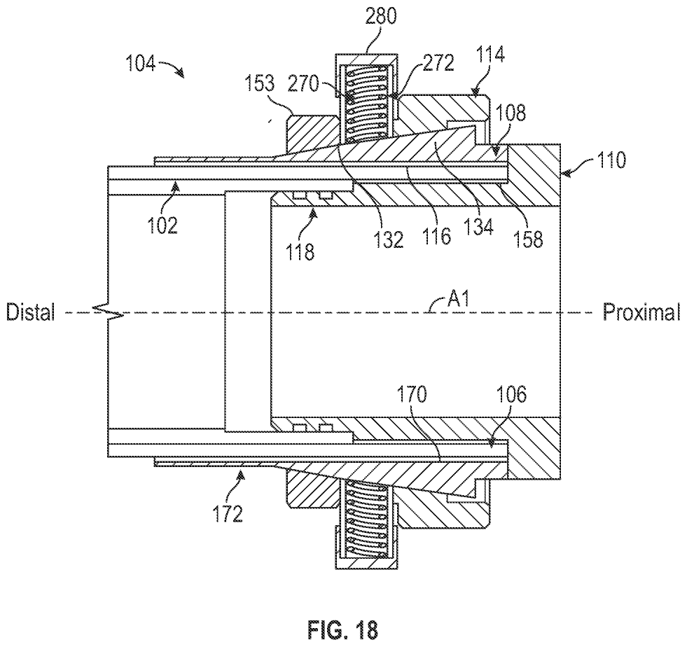

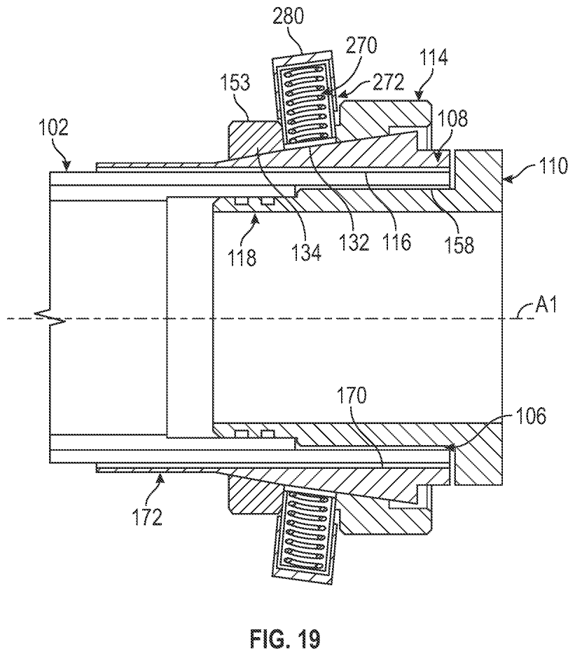

FIG. 18 and FIG. 19 each illustrate an example pipe connection 104 including one or more radial springs 270, according to one or more examples of the present disclosure, Also shown in FIG. 18 and FIG. 19 is a longitudinal axis A1, and orientation indicators Proximal and Distal. In such an example, the sleeve 114 can define one or more radial spring bores 272 adapted to receive, and retain, each radial spring of the one or more radial springs 270 therein. The one or more radial spring bores 272 can be realized in the form of one or more apertures, passages, or tubular bodies formed integrally with, or removably secured to or within, the sleeve 114.

In one example, each radial spring bore of the one or more radial spring bores 272 can be a cylindrical aperture extending radially through the first cam surface 132 and the outer sleeve surface 153, such as orthogonally to the longitudinal axis A1 (as shown in FIG. 18), or orthogonally to the first cam surface 132 and the first tapered surface 134 (as shown in FIG. 19). In another example, each radial spring bore of the one or more radial spring bores 272 can extend radially through the first cam surface 132 and radially outwardly beyond the outer sleeve surface 153. For example, each radial spring bore of the one or more radial spring bores 272 can be partially formed by a tubular or cylindrical body secured to the sleeve 114, such as via a press fit, a taper fit, or threaded engagement therebetween. In still further examples, each radial spring bore of the one or more radial spring bores 272 can be partially formed by an aperture, or passage, of the housing 112, such as to enable each radial spring of the one or more radial springs 270 to be inserted through the housing 112 and into the sleeve 114 once the sleeve 114 is secured to the housing 112.

The one or more radial springs 270 and the one or more radial spring bores 272 can each include various numbers of individual radial springs and individual radial springs bores, respectively. For example, the one or more radial springs 270 and the one or more radial spring bores 272 can each include, but not limited to, one, two, three, four, five, six, seven, or eight individual radial springs, and individual radial springs bores, respectively. In some examples, such as in an example where the slip 108 includes, or is otherwise collectively formed by, the plurality of segments 155 (FIGS. 6A-6B & 8), the one or more radial springs 270 and the one or more radial spring bores 272 can each include a number of individual radial springs, and individual radial spring bores, that is proportional to a number of individual segments the plurality of segments 155 includes. For example, if the plurality of segments 155 includes six individual segments, such as each defining a sixty-degree section of the inner slip surface 170 and the outer slip surface 172, the one or more radial springs 270 can include six radial springs and the one or more radial spring bores 272 can include six radial spring bores.

In such an example, each radial spring bore of the one or more radial spring bores 272 can be radially spaced, relative to the longitudinal axis A1, by about sixty degrees circumferentially offset from one another, to thereby enable each radial spring of the one or more radial springs 270 to contact and engage a different segment of the plurality of segments 155. Each radial spring of the one or more radial springs 270 can be, for example, but is not limited to, a single or multi-rate compression spring. The one or more radial springs 270 can be made from materials, such as including, but not limited to, made from hardened steel, metal alloys adapted for strength and/or corrosion resistance, coated metals (e.g., nickel, epoxy, etc.), stainless steel, corrosion resistant and/or sour resistant alloys, austenitic nickel-chromium-based superalloys such as Inconel®, and/or high chrome.

During assembly or establishment of the pipe connection 104, the sleeve 114 can first be slipped over the open end 106 and moved distally along the composite pipe 102. The slip 108 can then be slipped over the open end 106, and sleeve 114 can be moved proximally over the slip 108 and secured to the housing 112 (FIGS. 1-2, 7, and 10-14). Next, each radial spring of the one or more radial springs 270 can be inserted through a radial spring bore of the one or more radial spring bores 272 into contact with the first tapered surface 134 of the slip 108. Finally, each radial spring of the one or more radial springs 270 can radially compressed and secured within each radial spring bore of the one or more radial spring bores 272, such as via the installation of a removable cap 280 onto each radial spring bore of the one or more radial spring bores 272, compress the first tapered surface 134 radially inwardly, to, in turn, cause the inner slip surface 170 to compress the inner liner 122, the outer liner 123, or any other layers of the composite pipe 102 against the outer insertion surface 158 of the insertion portion 118.

In view of the above, the one or more radial springs 270 can enable the pipe connection 104 to provide an additional compression force to the composite pipe 102, such as beyond or greater than the fixed compression force, or initial preload, provided by the sleeve 114 to the slip 108 when the sleeve 114 is secured to the housing 112. Moreover, as the one or more radial springs 270 can compress the slip 108 radially inwardly, such as in response to plastic deformation, shrinkage, or other physical changes of the composite pipe 102, the one or more radial springs 270 can enable the pipe connection 104 to compress the composite pipe 102 with a consistent and continuous compression force that is not reduced or decreased by physical changes of the composite pipe 102. Therefore, the one or more radial springs 270 can increase the tensile load carrying capacity of the pipe connection 104, such as relative to existing composite pipe connections that engage a composite pipe with a fixed initial preload or compression force.

In some examples, the one or more radial springs 270 can be used as a supplementary method, in addition to the use of fluid pressure between the mandrel 110 and the slip 108, of providing an additional compression force to the composite pipe 102 beyond the fixed compression force or initial preload provided by the sleeve 114 to the slip 108 when the sleeve 114 is secured to the housing 112. In other examples, the one or more radial springs 270 can be used an alternative method, such as alternatively to the use of fluid pressure between the mandrel 110 and the slip 108, of providing an additional compression force to the composite pipe 102 beyond the fixed compression force or initial preload provided by the sleeve 114 to the slip 108 when the sleeve 114 is secured to the housing 112. In such examples, it can be appreciated that the head portion 120 may not include the one or more first sealing slots 142 (FIG. 2) and the head portion 120 may not be configured to translate axially within the housing 112.

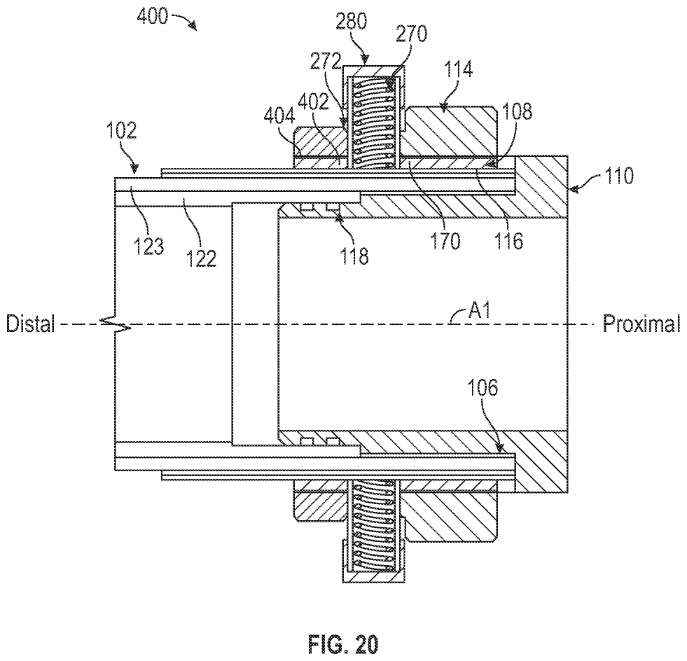

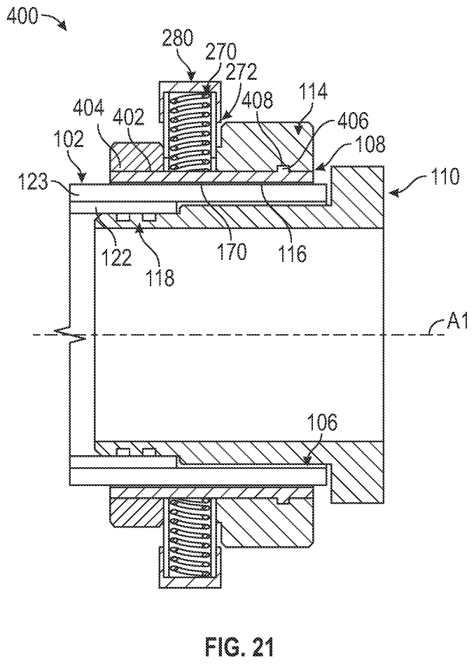

FIGS. 20-21 illustrate an example pipe connection 400 including one or more radial springs 270. Also shown in FIGS. 20-21 is a longitudinal axis A1, and orientation indicators Proximal and Distal. The pipe connection 400 can be similar to the pipe connection 104 shown in, and described with reference to, FIGS. 18-19, except in the that the slip 108 can define a first contacting surface 402 and the sleeve 114 can define a second contacting surface 404. The first contacting surface 402 can be an outermost surface of the slip 108 adapted to be received within the sleeve 114. and the second contacting surface 404 can be an innermost surface of the sleeve 114 adapted to contact the first contacting surface 402 when the slip 108 is received within the sleeve 114.

As such, the first contacting surface 402 and the second contacting surface 404 can be similar to the first tapered surface 134, and the second contacting surface 404 can be similar to the first cam surface 132, except in that, in some examples, such as shown in, and described below with reference to, FIGS. 18-19, the first contacting surface 402 and the second contacting surface 404 can be non-tapered, or otherwise sloped, surfaces. In some examples, such as shown in FIG. 20, the first contacting surface 402 and the second contacting surface 404 can extend entirely parallel to, and laterally offset from, the longitudinal axis A1. In other examples, such as shown in FIG. 21, the first contacting surface 402 can include a protruding portion 406 and the second contacting surface 404 can include a receiving portion 408.

The protruding portion 406 can generally be a protrusion, projection, or otherwise a length of the first contacting surface 402 extending radially outward beyond a radial distance, relative to the longitudinal axis A1, of other portions or lengths of the first contacting surface 402. Similarly, the receiving portion 408 can be a recess or inset portion or length of the second contacting surface 404 extending a lesser radial distance toward the longitudinal axis A1 relative to other portions or lengths of the second contacting surface 404. The receiving portion 408 can be sized and shaped to receive the protruding portion 406 to help prevent relative longitudinal movement between the slip 108 and the sleeve 114.

The second contacting surface 404 of the sleeve 114 can engage the first contacting surface 402 of the slip 108 when the sleeve 114 is secured to the housing 112 (FIGS. 1-2, 7, and 10-14). For example, during assembly or establishment of the pipe connection 400, the slip 108 can first be positioned within the sleeve 114, and both the slip 108 and the sleeve 114 can then be collectively slipped over the open end 106. As the slip 108 is positioned within the sleeve 114, the first contacting surface 402 of the slip 108 can contact and engage the second contacting surface 404 of the sleeve 114; and the protruding portion 406 can be at least partially received within the receiving portion 408 to limit relative movement between the slip 108 and the sleeve 114.

Next, each radial spring of the one or more radial springs 270 can be inserted into a radial spring bore of the one or more radial spring bores 272, through the second contacting surface 404, and into contact with the first contacting surface 402 of the slip 108. Finally, each radial spring of the one or more radial springs 270 can radially compressed and secured within each radial spring bore of the one or more radial spring bores 272, such as via the installation of a removable cap 280 onto each radial spring bore of the one or more radial spring bores 272, to compress the first contacting surface 402 radially inwardly, to, in turn, cause the inner slip surface 170 to compress the inner liner 122, the outer liner 123, or any other layers of the composite pipe 102 against the outer insertion surface 158 of the insertion portion 118.

In view of the above, the one or more radial springs 270 can enable the pipe connection 400 to provide an additional compression force to the composite pipe 102, such as beyond or greater than the fixed compression force, or initial preload, provided by the sleeve 114 to the slip 108 when the sleeve 114 is secured to the housing 112. Moreover, as the one or more radial springs 270 can compress the slip 108 radially inwardly, such as in response to plastic deformation, shrinkage, or other physical changes of the composite pipe 102, the one or more radial springs 270 can enable the pipe connection 400 to compress the composite pipe 102 with a consistent and continuous compression force that is not reduced or decreased by physical changes of the composite pipe 102. Therefore, the one or more radial springs 270 can increase the tensile load carrying capacity of the pipe connection 104, such as relative to existing composite pipe connections that engage a composite pipe with a fixed initial preload or compression force.

The above detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventor also contemplates examples in which only those elements shown or described are provided.

Moreover, the present inventor also contemplates examples using any combination or permutation of those elements shown or described (or one or more aspects thereof), either with respect to a particular example (or one or more aspects thereof), or with respect to other examples (or one or more aspects thereof) shown or described herein. In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F. R. § 1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure.

This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

### EXAMPLES

The following, non-limiting examples, detail certain aspects of the present subject matter to solve the challenges and provide the benefits discussed herein, among others.

Example 1 is a pipe connection for connecting or terminating a composite pipe, the pipe connection comprising: a housing including a first coupling surface, a slip including a first tapered surface; a sleeve including a second coupling surface and a first cam surface, the second coupling surface configured to engage the first coupling surface of the housing to secure the sleeve to the housing, and the first cam surface configured to engage the first tapered surface of the slip to compress the slip into the composite pipe when the sleeve is secured to the housing; a mandrel including: an insertion portion configured to extend into an inner liner of the composite pipe to resist deformation of the composite pipe; and a head portion configured to engage the slip to compress the composite pipe with a compression force proportional to a fluid pressure within the composite pipe.

In Example 2, the subject matter of Example 1 includes, wherein: the slip includes a plurality of segments; and wherein each segment of the plurality of segments forms a radial section of an outer slip surface, the outer slip surface including the first tapered surface; and each segment of the plurality of segments defines a plurality of guide slots extending parallel to a longitudinal axis, each guide slot of the plurality of guide slots sized and shaped to receive a guide pin extending through the first tapered surface orthogonally to a longitudinal axis.

In Example 3, the subject matter of Example 2 includes, wherein the slip defines a first portion and a second portion, the first portion including the first tapered surface and the second portion including a plurality of distal slits extending parallel to the longitudinal axis.

In Example 4, the subject matter of Example 3 includes, an annular insert adapted to be compressively clamped between an inner slip surface of the slip and outer pipe surface of the composite pipe when the sleeve is secured to the housing.

In Example 5, the subject matter of Example 4 includes, wherein the annular insert is made from a composite or non-metallic material.

In Example 6, the subject matter of Examples 1-5 includes, wherein the pipe connection includes a locking system adapted to limit proximal movement of the slip within the sleeve.

In Example 7, the subject matter of Example 6 includes, wherein the locking system includes: one or more first half bores defined by a first portion of the slip, wherein each first half bore extends parallel to a longitudinal axis of the slip and defines a first inner surface; and one or more second half bores defined by a proximal portion of the sleeve, wherein each second half bore extends parallel to the longitudinal axis of the slip and includes a second inner surface, the second inner surface defining a first plurality of half threads; and one or more set screws each defining a second plurality of threads, the second plurality of threads configured to threadedly engage the first plurality of half threads.

In Example 8, the subject matter of Example 7 includes, wherein each half bore of the one or more first half bores includes a distal end surface extending orthogonally to the longitudinal axis between the first tapered surface and an inner slip surface, the distal end surface adapted to contact a set screw of the one or more set screws to limit proximal movement of the slip within the sleeve.

In Example 9, the subject matter of Examples 6-8 includes, wherein the locking system includes a series of concentric grooves extending distally into the sleeve and an internal ring adapted to contact and engage the sleeve and the slip within the series of concentric grooves to limit proximal movement of the slip.

In Example 10, the subject matter of Examples 6-9 includes, wherein the locking system includes an inner series of threads extending distally into the sleeve and a threaded ring adapted to engage the inner series of threads to limit proximal movement of the slip.

In Example 11, the subject matter of Examples 1-10 includes, wherein at least one of the housing, the slip, the sleeve, or the mandrel is made from a non-metallic material.

In Example 12, the subject matter of Examples 1-11 includes, wherein an inner liner of the composite pipe forms a male taper and the insertion portion of the mandrel forms a female taper, or the inner liner of the composite pipe forms a female taper and an insertion portion of the mandrel forms a male taper.

In Example 13, the subject matter of Examples 1-12 includes, wherein the insertion portion of the mandrel forms a male or forward taper, or female or reverse taper.

Example 14 is a pipe connection for connecting or terminating a composite pipe, the pipe connection comprising: a housing including a first coupling surface; a slip including a first tapered surface; a sleeve including a second coupling surface and a first cam surface, the second coupling surface configured to engage the first coupling surface of the housing to secure the sleeve to the housing, and the first cam surface configured to engage the first tapered surface of the slip to compress the slip into the composite pipe when the sleeve is secured to the housing; a mandrel including a head portion configured to engage the slip to compress the composite pipe with a compression force proportional to a fluid pressure within the composite pipe; an insertion portion configured to extend into the composite pipe to resist deformation of the composite pipe; and a strain relief element configured to engage the composite pipe to compress the composite pipe with a compression force proportional to a longitudinal distance between a first end and a second end of the strain relief element.

In Example 15, the subject matter of Example 14 includes, wherein the first end is compressively clamped between the first tapered surface and first cam surface when the sleeve is secured to the housing, and the second end is secured to the composite pipe distally to the sleeve.

In Example 16, the subject matter of Example 15 includes, wherein the first end is compressively clamped between the slip and an outer pipe surface when the sleeve is secured to the housing, and the second end is secured to the composite pipe distally to the sleeve.

In Example 17, the subject matter of Examples 14-16 includes, wherein the strain relief element is made from a non-metallic material.

In Example 18, the subject matter of Examples 14-17 includes, wherein the strain relief element includes a first end and a second end, the first end secured to a second portion of the slip and the second end secured to the composite pipe distally to the pipe connection.

In Example 19, the subject matter of Example 18 includes, wherein the second portion of the slip includes a projection extending radially outward from a second portion of the slip, the projection adapted to engage a retaining ring to prevent distal translation of the retaining ring and the first end of the strain relief element relative to the slip.

In Example 20, the subject matter of Examples 14-19 includes, wherein the pipe connection includes a nut adapted to adjust the compression force applied to composite pipe by the strain relief element.

In Example 21, the subject matter of Example 20 includes, wherein a distal portion of the sleeve defines a first series of threads and the nut defines a second series of threads adapted to threadedly engage the first series of threads; and wherein of the second series of threads within the first series of threads causes the first end of the strain relief element to translate proximally or distally, to increase or decrease, respectively, the longitudinal distance between the first end and the second end of the strain relief element.

Example 22 is a pipe connection for connecting or terminating a composite pipe, the pipe connection comprising: a housing including a first coupling surface; a slip including a first contacting surface; a sleeve including a second coupling surface and a second contacting surface, the second coupling surface configured to engage the first coupling surface of the housing to secure the sleeve to the housing, and the second contacting surface configured to engage the first contacting surface of the slip when the sleeve is secured to the housing; a mandrel including: an insertion portion configured to extend into an inner liner of the composite pipe to resist deformation of the composite pipe; a head portion configured to engage the slip; and one or more radial springs extending radially through the housing, the one or more radial springs adapted to engage the first contacting surface of the slip to compress the composite pipe against the insertion portion.

In Example 23, the subject matter of Example 22 includes, wherein the first contacting surface and the second contacting surface each extend parallel to a longitudinal axis.

In Example 24, the subject matter of Examples 22-23 includes, wherein the first contacting surface is a first tapered surface and the second contacting surface is a first cam surface, the first tapered surface adapted to engage the first cam surface to cause the slip to compress the composite pipe against the insertion portion when the sleeve is secured to the housing.

In Example 25, the subject matter of Examples 22-24 includes, wherein the sleeve defines one or more first spring bores each adapted to receive a radial spring of the one or more radial springs, the one or more first spring bores extending radially through the sleeve orthogonally to a longitudinal axis or the first contacting surface and the second contacting surface.

In Example 26, the subject matter of Example 25 includes, wherein: the slip includes a plurality of segments, each segment of the plurality of segments forming a radial section of an outer slip surface; and the one or more radial springs and the one or more first spring bores each include a number of radial springs, and a number of first spring bores, respectively, that is proportional to a number of individual segments the plurality of segments includes.

In Example 27, the subject matter of Examples 22-26 includes, a strain relief element configured to engage the composite pipe to compress the composite pipe with a compression force proportional to a longitudinal distance between a first end and a second end of the strain relief element.

In Example 28, the subject matter of Examples 26-27 includes, wherein: the plurality of segments includes six individual segments each defining a sixty-degree radial section of the outer slip surface, the one or more radial springs includes six radial springs; and the one or more first spring bores includes six individual first spring bores.

Example 29 is a pipe connection for connecting or terminating a composite pipe, the pipe connection comprising: a housing including a first coupling surface; a slip including a first tapered surface; a sleeve including a second coupling surface and a first cam surface, the second coupling surface configured to engage the first coupling surface of the housing to secure the sleeve to the housing, and the first cam surface configured to engage the first tapered surface of the slip to cause the slip to compress the composite pipe when the sleeve is secured to the housing, a mandrel including: an insertion portion configured to extend into an inner liner of the composite pipe to resist deformation of the composite pipe; a head portion configured to engage the slip; and a longitudinal spring adapted to be received about the head portion of the mandrel, the longitudinal spring adapted to engage the slip to cause the slip to compress the composite pipe against the insertion portion.

In Example 30, the subject matter of Example 29 includes, wherein the longitudinal spring extends between an abutment surface of the slip and a second surface of the head portion, the abutment surface and the second surface each extending orthogonally to a longitudinal axis; and wherein the longitudinal spring is adapted to cause the slip to translate axially distally within the sleeve to compress the composite pipe against the insertion portion.

In Example 31, the subject matter of Example 30 includes, wherein the longitudinal spring encompasses a proximal annular surface of the head portion, the proximal annular surface defining a diameter less than a diameter defined by the head portion between a first surface of the head portion and the second surface of the head portion.

In Example 32, the subject matter of Example 31 includes, wherein the longitudinal spring is a compression spring.

In Example 33, the subject matter of Example 32 includes, a strain relief element configured to engage the composite pipe to compress the composite pipe with a compression force proportional to a longitudinal distance between a first end and a second end of the strain relief element.

Example 34 is a pipe connection for connecting or terminating a composite pipe, the pipe connection comprising: a housing including a first coupling surface; a slip including a first tapered surface; a sleeve including a second coupling surface and a first cam surface, the second coupling surface configured to engage the first coupling surface of the housing to secure the sleeve to the housing, and the first cam surface configured to engage the first tapered surface of the slip to compress the slip to into biting engagement with the composite pipe when the sleeve is secured to the housing; and a mandrel including: a head portion configured to compress the slip to bitingly engage the composite pipe with a compression force proportional to a fluid pressure within the composite pipe; and an insertion portion configured to extend into an inner liner of the composite pipe to resist deformation of the composite pipe.

In Example 35, the subject matter of Example 34 includes, wherein the housing defines a housing bore sized and shaped to receive and enable axial translation of the head portion of the mandrel within the housing bore; and wherein the head portion includes a first sealing element configured to establish a fluid-tight seal within the housing bore to cause the mandrel to translate axially distally within the housing bore in response to an increase in the fluid pressure within the composite pipe.

In Example 36, the subject matter of Example 35 includes, wherein the head portion of the mandrel defines a first surface and a second surface, the first surface opposing an end surface of the housing bore and the second surface opposing an abutment surface of the slip, wherein the second surface is configured to contact the abutment surface to drive the slip axially distally in response to an increase in the fluid pressure within the composite pipe.

In Example 37, the subject matter of Example 36 includes, wherein the slip includes a second tapered surface longitudinally offset from the first tapered surface and the sleeve includes a second cam surface longitudinally offset from the first cam surface; and wherein axial distal translation of the slip causes the first tapered surface and the second tapered surface to slidingly engage the first cam surface and the second cam surface, respectively, to compress the slip into biting engagement with the composite pipe.

In Example 38, the subject matter of Example 37 includes, wherein the insertion portion of the mandrel includes a second sealing element configured to establish a fluid-tight seal between the insertion portion and an inner liner of the composite pipe.

In Example 39, the subject matter of Example 38 includes, wherein the first coupling surface defines a first plurality of threads and the second coupling surface defines a second plurality of threads, the first plurality of threads configured to threadedly engage the second plurality of threads to secure the sleeve to the housing.

In Example 40, the subject matter of Examples 38-39 includes, wherein the sleeve defines one or more first bores and the housing defines one or more second bores; and wherein the one or more second bores is formed in corresponding radial positions relative to the one or more first bores; and wherein each of the one or more first bores and each of the one or more second bores are configured to concurrently accept a fastener to removably secure the sleeve to the housing.

In Example 41, the subject matter of Examples 34-40 includes, wherein the pipe connection includes a strain relief element encompassing a length of the composite pipe extending distally from the sleeve, the strain relief element configured to engage the composite pipe with a compression force based on distal translation of the composite pipe relative to the sleeve.

In Example 42, the subject matter of Example 41 includes, wherein the sleeve includes a proximal portion including the second coupling surface and a distal portion including a flange configured to retain a first end of the strain relief element between a distal end surface of the sleeve and a proximal end surface of the flange to secure the strain relief element to the sleeve.

In Example 43, the subject matter of Example 42 includes, wherein the distal portion of the sleeve defines a first plurality of bores and a second plurality of bores, the first plurality of bores extending through the distal end surface parallel to and laterally offset from a longitudinal axis, and the second plurality of bores extending through the proximal end surface of the flange parallel to and laterally offset from a longitudinal axis; wherein the second plurality of bores are formed in corresponding radial positions relative to the first plurality of bores; and wherein each of the first plurality of bores and each of the second plurality of bores are configured to concurrently accept a fastener to removably secure the flange to the distal portion of the sleeve.

In Example 44, the subject matter of Examples 42-43 includes, wherein the distal portion of the sleeve defines a first plurality of bores extending through the distal end surface parallel to and laterally offset from a longitudinal axis; and wherein each of the first plurality of bores, and a first end of the strain relief element, are configured to concurrently accept a fastener to removably secure the strain relief element to the distal portion of the sleeve.

Example 45 is a pipe connection for connecting or terminating a composite pipe, the pipe connection comprising: a housing including a first coupling surface; a slip including a first tapered surface; a sleeve including a second coupling surface and a first cam surface, the second coupling surface configured to engage the first coupling surface of the housing to secure the sleeve to the housing, and the first cam surface configured to engage the first tapered surface of the slip to compress the slip to into biting engagement with the composite pipe when the sleeve is secured to the housing, and a mandrel including a head portion and an insertion portion configured to extend into the composite pipe to resist deformation of the composite pipe; and a strain relief element configured to frictionally engage a length of the composite pipe extending distally from the sleeve with a compression force based on translation of the composite pipe relative to the sleeve.

In Example 46, the subject matter of Example 45 includes, wherein the sleeve includes a proximal portion including the second coupling surface and a distal portion including a flange configured to retain a first end of the strain relief element between a distal end surface of the sleeve and a proximal end surface of the flange to secure the strain relief element to the sleeve.

In Example 47, the subject matter of Example 46 includes, wherein the distal portion of the sleeve defines a first plurality of bores and a second plurality of bores, the first plurality of bores extending through the distal end surface parallel to and laterally offset from a longitudinal axis, and the second plurality of bores extending through the proximal end surface of the flange parallel to and laterally offset from a longitudinal axis; wherein the second plurality of bores are formed in corresponding radial positions relative to the first plurality of bores; and wherein each of the first plurality of bores and each of the second plurality of bores are configured to concurrently accept a fastener to removably secure the flange to the distal portion of the sleeve.

In Example 48, the subject matter of Examples 44-47 includes, wherein the sleeve defines a first plurality of bores extending parallel to and laterally offset from a longitudinal axis; and wherein each of the first plurality of bores, and a first end of the strain relief element, are configured to concurrently accept a fastener to removably secure the strain relief element to the distal portion of the sleeve.

In Example 49, the subject matter of Examples 44-48 includes, wherein a second end of the strain relief element is secured to the composite pipe with one or more clamps circumferentially encompassing the strain relief element and the composite pipe.

In Example 50, the subject matter of Examples 44-49 includes, wherein the strain relief element is a metallic wire-mesh cable pulling grip.

Example 51 is a method of establishing a pipe connection for connecting or terminating a composite pipe, the method comprising: cutting the composite pipe at connection location to expose an open end of the composite pipe; axially reinforcing a length of the composite pipe extending distally from the open end; inserting an insertion portion of a mandrel configured to resist deformation of the composite pipe into the open end; positioning the mandrel between a housing and a slip; and securing a sleeve to the housing to couple the open end of the composite pipe to the pipe connection.

In Example 52, the subject matter of Example 51 includes, wherein axially reinforcing the length of the composite pipe includes encompassing a fiber-reinforced layer of the composite pipe with fiber-reinforced tape.

In Example 53, the subject matter of Examples 51-52 includes, wherein axially reinforcing the length of the composite pipe includes compressing a heating element against the fiber-reinforced tape to thermally bond the fiber-reinforced tape to the fiber-reinforced layer.

In Example 54, the subject matter of Examples 51-53 includes, wherein the method includes sliding a strain relief element over the length of the composite pipe and securing a first end of the strain relief element to the sleeve.

In Example 55, the subject matter of Examples 51-54 includes, wherein positioning the mandrel between the housing and the slip of the pipe connection includes establishing a fluid tight seal between the housing and a head portion of the mandrel and a fluid tight seal between an inner liner of the composite pipe and the insertion portion of the mandrel.

In Example 56, the subject matter of Example 55 includes, wherein the method includes pumping fluid through the composite pipe to cause: the slip to compress the open end of the composite pipe against the insertion portion of the mandrel with a compression force proportional to a fluid pressure within the composite pipe; and the strain relief element to compress the length of the composite pipe a compression force proportional to distal translation of the open end of the composite pipe relative to the sleeve.

Example 57 is at least one machine-readable medium including instructions that, when executed by processing circuitry, cause the processing circuitry to perform operations to implement of any of Examples 1-56.

Example 58 is an apparatus comprising means to implement of any of Examples 1-56.

Example 59 is a system to implement of any of Examples 1-56.

Example 60 is a method to implement of any of Examples 1-56.

1-33. (canceled)

34. A pipe connection for connecting or terminating a composite pipe, the pipe connection comprising:
a housing including a first coupling surface;
a slip including a first tapered surface;
a sleeve including a second coupling surface and a first cam surface, the second coupling surface configured to engage the first coupling surface of the housing to secure the sleeve to the housing, and the first cam surface configured to engage the first tapered surface of the slip to compress the slip into the composite pipe when the sleeve is secured to the housing;
a mandrel including a head portion configured to engage the slip to compress the composite pipe with a compression force proportional to a fluid pressure within the composite pipe;
an insertion portion configured to extend into the composite pipe to resist deformation of the composite pipe; and
a strain relief element configured to engage the composite pipe to compress the composite pipe with a compression force proportional to a longitudinal distance between a first end and a second end of the strain relief element.

35. The pipe connection of claim 34, wherein the first end is compressively clamped between the first tapered surface and first cam surface when the sleeve is secured to the housing, and the second end is secured to the composite pipe distally to the sleeve.

36. The pipe connection of claim 35, wherein the first end is compressively clamped between the slip and an outer pipe surface when the sleeve is secured to the housing, and the second end is secured to the composite pipe distally to the sleeve.

37. The pipe connection of claim 34, wherein the strain relief element is made from a non-metallic material.

38. The pipe connection of claim 34, wherein the strain relief element includes a first end and a second end, the first end secured to a second portion of the slip and the second end secured to the composite pipe distally to the pipe connection.

39. The pipe connection of claim 38, wherein the second portion of the slip includes a projection extending radially outward from a second portion of the slip, the projection adapted to engage a retaining ring to prevent distal translation of the retaining ring and the first end of the strain relief element relative to the slip.

40. The pipe connection of claim 34, wherein the pipe connection includes a nut adapted to adjust the compression force applied to the composite pipe by the strain relief element.

41. The pipe connection of claim 40, wherein a distal portion of the sleeve defines a first series of threads and the nut defines a second series of threads adapted to threadedly engage the first series of threads; and wherein engaging the second series of threads within the first series of threads causes the first end of the strain relief element to translate proximally or distally, to increase or decrease, respectively, the longitudinal distance between the first end and the second end of the strain relief element.

42. A pipe connection for connecting or terminating a composite pipe, the pipe connection comprising:
a housing including a first coupling surface;
a slip including a first tapered surface;
a sleeve including a second coupling surface and a first cam surface, the second coupling surface configured to engage the first coupling surface of the housing to secure the sleeve to the housing, and the first cam surface configured to engage the first tapered surface of the slip to compress the slip into biting engagement with the composite pipe when the sleeve is secured to the housing;
a mandrel including an insertion portion, the insertion portion configured to extend into an inner liner of the composite pipe to resist deformation of the composite pipe; and
a reinforcement layer, configured to reinforce a length of the composite pipe extending distally from an open end of the composite pipe.

43. The pipe connection of claim 42, wherein the mandrel includes:
a head portion configured to compress the slip to bitingly engage the composite pipe with a compression force proportional to a fluid pressure within the composite pipe.

44. The pipe connection of claim 42, wherein:
the reinforcement layer is configured for axially reinforcing the composite pipe; and
the reinforcement layer includes a fiber-reinforced tape that is configured to be applied over a fiber-reinforced layer of the composite pipe.

45. The pipe connection of claim 44, wherein the reinforcement layer is thermally bonded to the fiber-reinforced layer.

46. A pipe connection for connecting or terminating a composite pipe, the pipe connection comprising:
a housing including a first coupling surface;
a slip including a first tapered surface, wherein;
the slip includes a plurality of segments; and wherein each segment of the plurality of segments forms a radial section of an outer slip surface, the outer slip surface including the first tapered surface; and
each segment of the plurality of segments defines a plurality of guide slots extending parallel to a longitudinal axis, each guide slot of the plurality of guide slots sized and shaped to receive a guide;
a sleeve including a second coupling surface and a first cam surface, the second coupling surface configured to engage the first coupling surface of the housing to secure the sleeve to the housing, and the first cam surface configured to engage the first tapered surface of the slip to compress the slip into the composite pipe when the sleeve is secured to the housing; and
a mandrel including an insertion portion, the insertion portion configured to extend into an inner liner of the composite pipe to resist deformation of the composite pipe.

47. The pipe connection of claim 46, wherein the mandrel includes:
a head portion configured to engage the slip to compress the composite pipe with a compression force proportional to a fluid pressure within the composite pipe.

48. The pipe connection of claim 46, wherein:
the guide slots only extend partially through the slip; and
the guides are substantially fixed with respect to the sleeve.

49. The pipe connection of claim 46, wherein the slip defines a first portion and a second portion, the first portion including the first tapered surface and the second portion including a plurality of distal slits extending parallel to the longitudinal axis.

50. The pipe connection of claim 49, further comprising an annular insert adapted to be compressively clamped between an inner slip surface of the slip and outer pipe surface of the composite pipe when the sleeve is secured to the housing.

51. The pipe connection of claim 50, wherein the annular insert is made from a composite or non-metallic material.

52. The pipe connection of claim 46, wherein the pipe connection includes a locking system adapted to limit proximal movement of the slip within the sleeve.

53. The pipe connection of claim 52, wherein the locking system includes:
one or more first half bores defined by a first portion of the slip, wherein each first half bore extends parallel to a longitudinal axis of the slip and defines a first inner surface;
one or more second half bores defined by a proximal portion of the sleeve, wherein each second half bore extends parallel to the longitudinal axis of the slip and includes a second inner surface, the second inner surface defining a first plurality of half threads; and
one or more set screws each defining a second plurality of threads, the second plurality of threads configured to threadedly engage the first plurality of half threads.

54. The pipe connection of claim 53, wherein each half bore of the one or more first half bores includes a distal end surface extending orthogonally to the longitudinal axis between the first tapered surface and an inner slip surface, the distal end surface adapted to contact a set screw of the one or more set screws to limit proximal movement of the slip within the sleeve.

55. The pipe connection of claim 52, wherein the locking system includes a series of concentric grooves extending distally into the sleeve and an internal ring adapted to contact and engage the sleeve and the slip within the series of concentric grooves to limit proximal movement of the slip.
